(19) United States
(12) Patent Application Publication
(10) Pub. No.: US 2011/0095575 A1
(43) Pub. Date: Apr. 28, 2011

(54) MOVABLE ROOF STRUCTURE OF VEHICLE

(75) Inventors: Satoru HASHIMOTO, Hiroshima (JP); Yukio NAKAMURA, Hiroshima (JP); Shigeyuki MORI, Hiroshima (JP); Isao TODA, Hiroshima (JP)

(73) Assignee: MAZDA MOTOR CORPORATION, Hiroshima (JP)

(21) Appl. No.: 12/904,615

(22) Filed: Oct. 14, 2010

(30) Foreign Application Priority Data
Oct. 22, 2009 (JP) 2009-243020
Oct. 22, 2009 (JP) 2009-243021
Oct. 26, 2009 (JP) 2009-245590

(51) Int. Cl. B60J 7/047

(52) U.S. Cl. 296/220.01; 296/108; 296/107.17

(57) ABSTRACT

A roof member comprises a front roof and a rear roof which are connected to each other, at least one of which is made of a board-shaped hard roof member. A grip (i.e., an operational member) to be gripped by a passenger is provided at a specified position of the front roof so as to transmit an opening-operational force or closing-operation force by the passenger to the roof member. A guide shaft (i.e., a moving mechanism) is provided to position the grip such that the grip is movable relatively to the roof member. Accordingly, a movable roof structure of a vehicle which can properly improve the operation and handling and decrease the operational force with a simple and light mechanism can be provided.

### BACKGROUND OF THE INVENTION

The present invention relates to a movable roof structure of a vehicle, such as an open car, in which a roof member covering over an upper part of a vehicle compartment can be opened.

Japanese Patent Laid-Open Publication No. 2007-261405 or EP2006139 A1, for example, discloses an example of the above-described movable roof structure. Herein, a roof member comprises three split parts of a front roof panel, a middle roof panel, and a back window. These roof panels are foldable so as to be stored in a storage chamber, and a deck cover is further provided so as to cover over the stored roof panels for securing a good appearance. These three roof panels are connected via a link mechanism, and in order to operate these roof panels electrically, a drive motor as a drive source and a gear mechanism to transmit a rotation of this motor to the above-described link mechanism are provided.

The above-described structure with an electrically-operational mechanism, however, has a problem in that it would become complex, its parts number, weight, and costs would be improperly increased, and its handling would be poor.

### SUMMARY OF THE INVENTION

The present invention has been devised in view of the above-described problem, and an object of the present invention is to provide a movable roof structure of a vehicle which can properly improve its operation and handling and decrease its operational force, with a simple and light mechanism.

According to the present invention, there is provided a movable roof structure of a vehicle, comprising a roof member provided so as to be positioned in a closing state to cover over an upper part of a vehicle compartment and an open state to open the upper part of the vehicle compartment, the roof member comprising a plurality of split sub roof members which are connected, at least one of which is made of a board-shaped hard roof member; the roof member being stored in a storage portion at a rear part of the vehicle compartment in a state in which the sub roof members are folded when being in the open state, an operational member to be operated by a passenger, the operational member being provided at a specified position of a front-side member of the sub roof members so as to transmit an opening-operational force or a closing-operation force by the passenger to the sub roof members for opening or closing the roof member, and a moving mechanism provided to position the operational member such that the operational member is movable relatively to the roof member.

According to the above-described invention, since the roof member comprising the plural split sub roof members which are connected is provided and its opening or closing is manually operated (handled) by a passenger, the mechanism for opening or closing the roof member can be properly simple and light, and also its operation and handling can be improved and its operational force can be decreased. Further, since the operational member is provided so as to be operated by a passenger and movable relatively to the roof member, the operation and handling of the roof member by the passenger can be further improved.

According to an embodiment of the present invention, the moving mechanism positions the operational member such that the operational member is movable relatively to the roof member substantially in a vehicle width direction. Thereby, since the operational member is movable relatively to the roof member substantially in the vehicle width direction, the passenger can easily grip and operate or handle the operational member, which is a grip member, for example, regardless of the position of the passenger's body or the passenger's own arm joint characteristics.

Herein, the above-described operational member may comprise a cylindrical member, and the moving mechanism may comprises a shaft member which is fixed at the front-side member of the sub roof members so as to extend substantially in the vehicle width direction and guide the cylindrical member by being inserted into a central hole of the cylindrical member.

According to another embodiment of the present invention, the roof member comprises two sub roof members which are connected to each other. Thereby, since the roof member is comprised of two split members, the structures of the roof member and the open roof mechanism can be simpler and lighter and the storage space of the roof member can be simplified accordingly.

According to another embodiment of the present invention, the roof member comprises at least a front roof member and a rear roof member, and both of the front and rear roof members are made of a hard roof member. Thereby, since both of the front and rear roof members are made of the hard roof member, the antitheft (burglarproof) and thereby the safety of the vehicle can be improved, and also the design for a nice-looking car can be secured.

According to another embodiment of the present invention, the roof member comprises at least a front roof member and a rear roof member, and the front roof member is made of a hard roof member. Thereby, since the front roof member, which may contribute to the safety the most, is made of the hard roof member, the vehicle is properly superior in antitheft. Further, the light weight of the vehicle can be properly achieved, compared with a case in which the whole of roof member is made of the hard roof member entirely. Additionally, since the front the front roof member is made of the hard roof member, the vehicle can be superior in car designing.

According to another embodiment of the present invention, the roof member comprises at least a front roof member and a rear roof member, and the rear roof member is made of a hard roof member. Thereby, since the rear roof member is made of the hard roof member, the appearance can be improved in case a rear window is attached to the rear roof member, and its structure can be better as well. Moreover, the light weight can be achieved, compared with a case in which the whole of roof member is made of the hard roof member entirely.

According to another embodiment of the present invention, means for allowing daylight to come into the vehicle compartment is provided at least at part of the sub roof members. Thereby, better lighting can provide comfortable circumstances in the vehicle compartment.

According to another embodiment of the present invention, at least part of the sub roof members is made of a light-transparent material. Thereby, the better lighting can be achieved with a simple structure without forming any window at the sub roof members or conducting any design changing. Herein, a semitransparent synthetic resin or a white canvas may be used as the light-transparent material.

According to another embodiment of the present invention, the roof member comprises at least a front roof member and a rear roof member, and the front roof member is made of a flexible and light-transparent material. Thereby, the light weight can be achieved, compared with a case in which the whole of roof member is made of the hard roof member entirely. Further, since the front roof member is made of the light-transparent material, the better lighting is available in accordance with the passenger's request, thereby further improve the comfortable circumstances in the vehicle compartment.

According to another embodiment of the present invention, the roof member comprises at least a front roof member and a rear roof member, and the front roof member is made of a light-transparent hard roof member. Thereby, since the front roof member, which may contribute to the safety the most, is made of the hard roof member, the vehicle is properly superior in antitheft. Further, since the front roof member has the light transparency, the better lighting is available, so that the comfortable circumstances in the vehicle compartment can be provided.

According to another embodiment of the present invention, the movable roof structure of a vehicle further comprises an assist mechanism to assist an operational force by the passenger. Thereby, since the operational force of the manual operation by the passenger is assisted (helped) by the assist mechanism, decreasing the operational force which may be necessary for the manual operation of the roof member can be achieved, so that the handling can be further improved.

According to another embodiment of the present invention, the assist mechanism assists the closing-operational force by the passenger for closing the roof member. Thereby, the operational force of closing the roof member can be decreased, so that the closing handling can be further improved. Herein, the assist mechanism may be comprised of a biasing means, such as a spring, for assisting (helping) the closing-operational force by the passenger for closing the roof member. In this case, decreasing of the operational force of closing the roof member can be achieved with a simple structure.

According to another embodiment of the present invention, the movable roof structure of a vehicle further comprises an open roof mechanism to provide a partially-open mode in which the roof member is partially open and held. Thereby, the open positions of the roof member are selectable, so that the passenger can be provided with comfortable feelings. Herein, the roof member can take a full-closing position, a partially-open position, and a full-open position.

According to another embodiment of the present invention, the open roof mechanism stops moving of the roof member in the middle of opening or closing operation of the roof member. Thereby, the passenger's having the comfortable feelings can be further improved.

According to another embodiment of the present invention, the open roof mechanism stops moving of the roof member in the middle of opening or closing operation of the roof member at any position. Thereby, adjusting the amount of outside-air induction or lighting is available in accordance with the passenger's request.

According to another embodiment of the present invention, the movable roof structure of a vehicle further comprises an opening mechanism to vertically move at least part of the roof member. Thereby, ventilation of the vehicle compartment can be improved.

According to another embodiment of the present invention, one of the sub roof members is movable in a vehicle longitudinal direction. Thereby, the partially-open mode can be secured when the sub roof member is moved, so that both of the outside-air induction or the ventilation of the vehicle compartment and lighting adjustment can be achieved.

Other features, aspects, and advantages of the present invention will become apparent from the following description which refers to the accompanying drawings.

### BRIEF DESCRIPTION OF THE DRAWINGS

FIG. 1 is a side view showing a movable roof structure of a vehicle according to a first embodiment of the present invention.

FIG. 2 is a plan view of a major part of FIG. 1.

FIG. 3 is an elevation view showing an arrangement structure of a rollover protecting member.

FIG. 4 is a perspective view showing a surrounding structure of a rear wheel house on the right of the vehicle and a wheel house reinforcement.

FIG. 5 is an exploded perspective view of respective gussets.

FIG. 6 is a partial enlarged sectional view of FIG. 3.

FIG. 7 is a side view in a roof-closed state.

FIG. 8 is a side view in a roof-popped-up state.

FIG. 9 is a side view in a roof-open state.

FIG. 10 is a partial sectional view taken along line A-A of FIG. 9.

FIG. 11 is a partial sectional view taken along line B-B of FIG. 9.

FIG. 12 is a partial enlarged side view showing a structure of a lock mechanism.

FIG. 13 is a sectional view taken along line C-C of FIG. 12.

FIG. 14 is a schematic perspective view showing the movable roof structure of a vehicle.

FIG. 15 is a side view showing a movable roof structure of a vehicle according to a second embodiment of the present invention.

FIG. 16 is a side view in a roof-popped-up state.

FIG. 17 is a side view in a roof-open state.

FIG. 18 is a partial enlarged sectional view of FIG. 15.

FIG. 19 is a partial sectional view taken along line D-D of FIG. 18.

FIG. 20 is a side view showing a partially-open state of a front roof.

FIG. 21 is a side view showing a state in which the front roof is opened more.

FIG. 22 is a side view showing a movable roof structure of a vehicle according to a third embodiment of the present invention.

FIG. 23 is a side view in a roof-closed state.

FIG. 24 is a side view showing a partially-open mode of a roof member.

FIG. 25 is a side view in a roof-popped-up state.

FIG. 26 is a side view in a roof-open state.

FIG. 27 is a schematic perspective view showing the movable roof structure of a vehicle.

FIG. 28 is a side view showing a movable roof structure of a vehicle according to a fourth embodiment of the present invention.

FIG. 29 is an enlarged side view of a major part of a roof member.

FIG. 30 is a side view showing a partially-open mode of the roof member.

FIG. 31 is a side view in a roof-popped-up state.

FIG. 32 is a side view in a roof-open state.

### DETAILED DESCRIPTION OF THE INVENTION

Hereinafter, preferred embodiments of the present invention will be described referring to the accompanying drawings. It should be understood that even though embodiments are separately described, single features thereof may be combined to additional embodiments.

### Embodiment 1

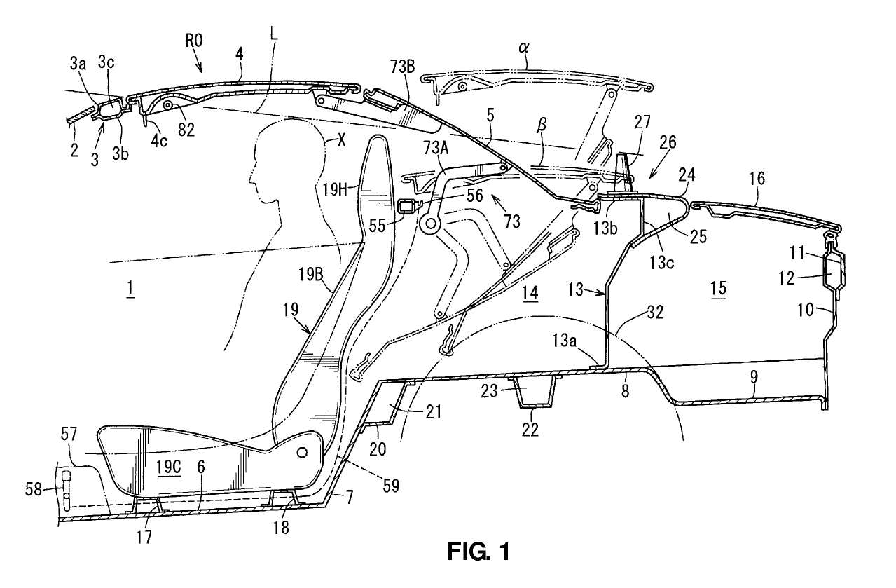

A first embodiment of the present invention will be described referring to FIGS. 1 through 14. The figures show a movable roof structure of an open car as a vehicle. In a side view of FIG. 1, the open car comprises a front header 3 which is a reinforcing member which extends in a vehicle width direction and supports an upper side of a windshield 2 at a front portion of a vehicle compartment 1, and a roof member RO which is provided so as to extend rearwardly from the front header 3 and form an upper portion of the vehicle compartment 1. The roof member RO is split into two parts, a front roof 4 and a rear roof 5. The front and rear roofs 4, 5 are supported so as to be opened and closed. In FIG. 1, a closing state of the roofs 4, 5 is shown by solid lines, a midway state of opening of the roofs 4, 5 is shown by two-dotted broken lines α, and a state in which the roofs 4, 5 are opened and stored in a roof storage space 14 is shown by two-dotted broken lines β.

The above-described front header 3, which is the reinforcing member having a header closed cross section 3c which extends in the vehicle width direction and is formed by a front header outer 3a and a front header inner 3b which are joined to each other, is connected to a pair of hinge pillars via a pair of front pillars having a closed cross section (not illustrated) at its both ends. The front pillar and the hinge pillar are, respectively, a vehicle-body rigidity member which has the closed cross section.

Meanwhile, a floor panel 6 to form a bottom face of the vehicle compartment 1 is provided, and a rear floor 8 is provided so as to extend substantially horizontally from a rear portion of the floor panel 6 via a kick-up portion 7 which stands up obliquely upwardly and rearwardly. A spare tire pan 9 which is concaved downwardly is integrally formed with a middle portion, in the vehicle width direction, of a rear portion of the rear floor 8. A rear end panel 10 which extends vertically is integrally joined to a rear end portion of the rear floor 8. A rear end member 11 which extends in the vehicle width direction is joined to a vehicle outside position of an upper portion of the rear end panel 10. A rear end closed cross section 12 which extends in the vehicle width direction is formed between the rear end member 11 and the rear end panel 10, which can increase the rigidity of a rear vehicle body.

Further, to a middle portion, in a vehicle longitudinal direction, of the above-described rear floor 8 is attached a rear bulkhead 13 which partitions a rear end of the vehicle compartment 1. This rear bulkhead 13 extends vertically, and the roof storage space 14 is formed in front of the rear bulkhead 13. Specifically, the roof storage space 14 where the opened roof member RO is stored is formed between a seat for passenger 19, which will be described below, and the rear bulkhead 13. A baggage room, i.e., a trunk room 15, is formed in back of the rear bulkhead 13. An upper part of the trunk room 15 is covered with a trunk lid 16.

The above-described roof storage space 14 is formed in back of the vehicle compartment 1, which constitutes a storage portion for the rear roof 5 which is opened, as shown by the two-dotted broken lines in FIG. 1. Herein, the above-described rear bulkhead 13 has a joint piece 13a which bends forwardly at its lower end, and a bending portion 13b which bends forwardly at its upper end. The upper portion of the rear bulkhead 13 is formed so as to have a U-shaped portion 13c including the bending 13b, which can increase the rigidity of the rear bulkhead 13 itself.

On the floor panel 6 is provided the seat 19 (the seat for passenger) in which a passenger is seated via plural seat brackets 17, 18 (or a cross member). This seat 19 comprises a seat cushion 19C and a seatback 19B integrally including a headrest 19H. Herein, this vehicle is equipped with two seats, a driver's seat and a passenger's seat. The above-described front header 3 is the reinforcing member which extends in the vehicle width direction in front of the seat 19 arranged in the vehicle compartment 1 and supports an upper side of the windshield 2 at a front portion of the vehicle compartment 1.

A cross member 20 extending in the vehicle width direction is provided between a back face of the kick-up portion 7 and a front lower face of the rear floor 8 so as to form a closed cross section 21 which extends in the vehicle width direction. Thereby, the rigidity of the lower vehicle body is increased.

Further, a rear cross member 22 extending in the vehicle width direction is joined to a lower face of a middle portion, in the vehicle width direction, of the rear floor 8 so as to form a closed cross section 23 which extends in the vehicle width direction. Thereby, the rigidity of the lower vehicle body is increased. Moreover, a sub frame, not illustrated, is attached to a lower portion of the rear cross member 22.

A rear deck member 24 is joined and fixed to the U-shaped portion 13c of the upper portion of the rear bulkhead 13 so as to cover from behind. Thereby, a rear deck closed cross section 25 extending in the vehicle width direction is formed between the rear bulkhead 13 and the rear deck member 24, thereby increasing the rigidity of a vehicle-body rear deck portion 26. Herein, the above-described rear deck member 24 is formed so as to have a U-shaped or V-shaped cross section which opens forwardly. That is, the rear deck member 24, which is the reinforcing member extending in the vehicle width direction, is provided at the rear deck portion 26.

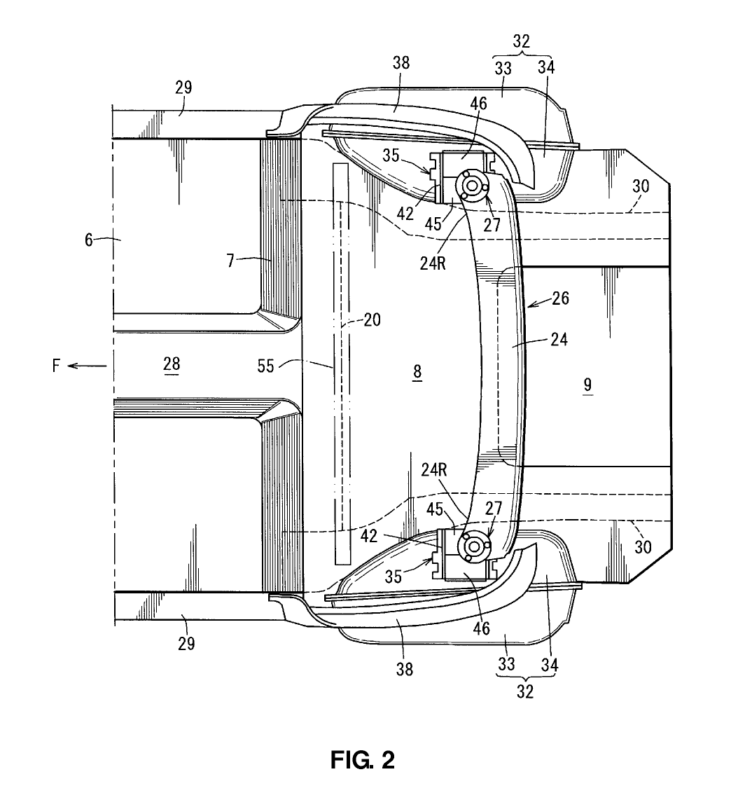

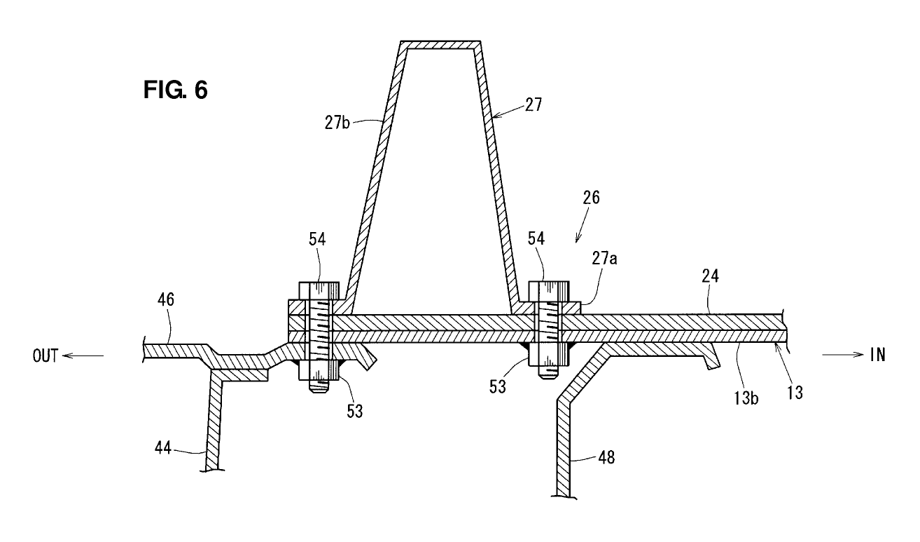

FIG. 2 is a plan view of a major part of FIG. 1. As shown in FIG. 2, the rear deck member 24 extends in the vehicle width direction, and its both-side ends bend forwardly so as to have forwardly-bending portions 24R, 24R. Rollover protecting members 27, 27 are attached to respective upper portions of the both forwardly-bending portions 24R, 24R. The rollover protecting members 27 are made of a hollow rigidity member, as shown in FIG. 6, and secure the safety of passengers by supporting the vehicle with the rollover protecting members 27 and the front header 3 in case the vehicle rolls over when the roofs 4, 5 are open. Accordingly, as shown in FIG. 1, the height of the rollover protecting members 27 is set so that a line L connecting an upper end of the rollover protecting member 27 and an upper end of the front header 3 can be located at a preferable height position for protection of the passenger X in the vehicle compartment 1.

Specifically, as shown in FIG. 1, the height of the rollover protecting members 27 is set so that the line L connecting the upper end of the rollover protecting member 27 and the upper end of the front header 3 can be higher than the height of the upper end of the seatback 19B of the seat 19 arranged in the vehicle compartment 1 (the height of the headrest 19H). Further, the rollover protecting members 27 are disposed, behind the roof storage space 14, away from each other in the vehicle width direction (two members 27, 27 in the present embodiment shown in FIG. 2), and these members 27, 27 are fixed to the forwardly-bending portions 24R, 24R.

In FIG. 2, a tunnel portion 28 is formed at a middle portion, in the vehicle width direction, of the floor panel 6 so as to project upwardly in the vehicle compartment 1 and extend in the vehicle longitudinal direction. Further, at both sides of the floor panel 26 are provided side sills 29, 29 which have a closed cross section, respectively. The side sill 29 is a vehicle-body rigidity member, which is formed by a side sill inner and a side sill outer which are joined to each other, extends in the vehicle longitudinal direction, and has a side-sill closed cross section extending in the vehicle longitudinal direction between the side sill inner and the side sill outer.

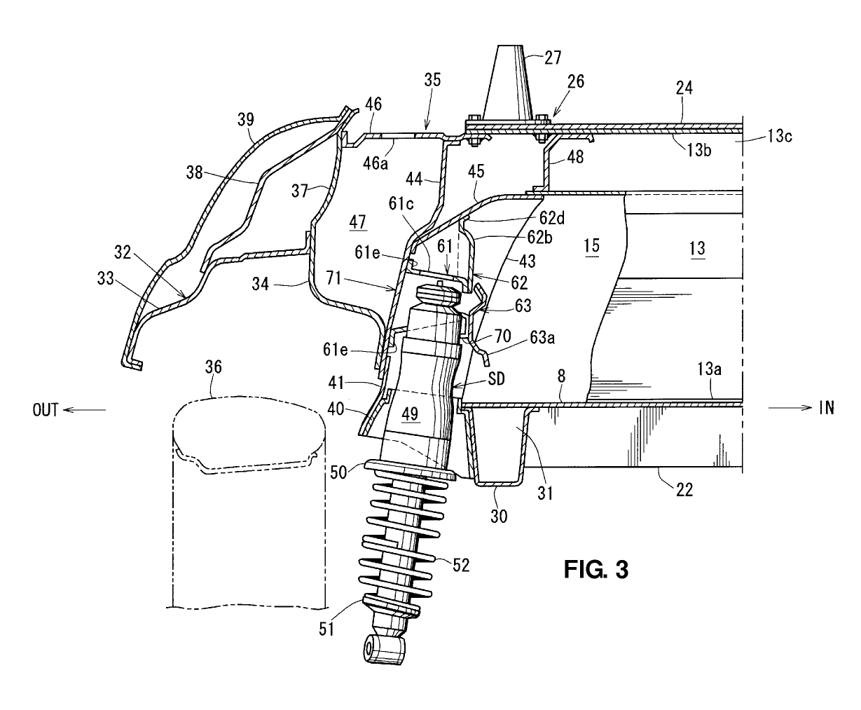

Further, rear side frames 30, 30 which are a reinforcing member extending in the vehicle longitudinal direction are joined and fixed to lower portions of the both sides of the rear floor 8. Between the rear floor 8 and the rear side frame 30 is formed a rear side closed cross section 31 (see FIG. 3) which extends in the vehicle longitudinal direction. The rear side frame 30 increases the rigidity of the lower vehicle body.

As shown in FIG. 2, right and left rear wheel houses 32, 32 are formed respectively on outward sides, in the vehicle width direction, of the rear side frames 30, 30. The rear wheel house 32 is comprised of a wheel house outer 33 and a wheel house inner 34 which are joined to each other.

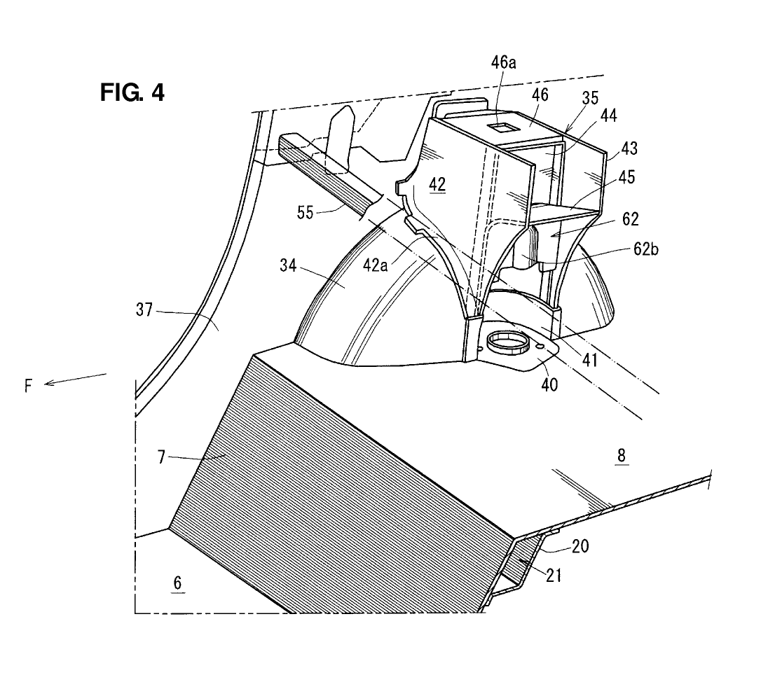

As shown in FIGS. 1 and 2, the rollover protecting member 27 is arranged at the rear deck portion 26 above the rear wheel house 32 at the rear portion of the vehicle compartment 1. Thus, the rollover protecting member 27 is arranged at a specified position corresponding to the rear wheel house 32. A wheel house reinforcement 35 to reinforce the rear wheel house 32 is provided at the rear wheel house 32, and the above-described rollover protecting member 27 is disposed at the specified position corresponding to this wheel house reinforcement 35. The wheel house reinforcement 35 and its surrounding structure will be described referring to FIGS. 3 and 4.

As shown in FIG. 3, the rear wheel house 32 which stores the rear wheel 36 therein is formed by the wheel house outer 33 and the wheel house inner 34 which are joined to each other. An outside portion of the rear wheel house 32 is constituted by a rear fender reinforcement 38 which extends between a rear quarter panel inner 37 and the wheel house outer 33 and a rear fender 39 which is positioned on the outward side of the rear fender reinforcement 38.

Further, as shown in FIG. 3, a suspension housing 40 which supports a damper SD of a rear suspension mechanism is formed on the outward side of the rear side frame 30. A suspension housing gusset 41 which is of an arc shape in a plan view is joined to a skirt portion of the suspension housing 40 so as to enclose an outer periphery of the skirt portion. The suspension housing gusset 41 extends upwardly and is joined to the wheel house inner 34.

As shown in FIG. 4, the suspension housing gusset 41 is also joined to a pair of package junctions 42, 43 which are away from each other longitudinally, a suspension housing reinforcement 44 which extends vertically is arranged between the pair of package junctions 42, 43, and the suspension housing reinforcement 44 is joined to the pair of package junctions 42, 43.

These members constitute a suspension support structure. The package junctions 42, 43 have a joint flange 42a at its lower-end edge, and are joined to inward faces of the wheel house inner 34 and the rear quarter panel inner 37 via the joint flange 42a. Moreover, the suspension housing reinforcement 44 arranged between the package junctions 42, 43 is joined to the package junctions 42, 43.

Further, as shown in FIG. 4, a junction lower member 45 is arranged at a middle position, in the vehicle vertical direction, of a portion between the package junctions 42, 43, and joined to the rear bulkhead 13.

As shown in FIG. 3, a junction upper member 46 is arranged at an upper-end edge of the suspension housing reinforcement 44 which is positioned between the package junctions 42, 43, and this junction upper member 46 is joined to the suspension housing reinforcement 44, the package junctions 42, 43, and the rear quarter panel inner 37, respectively. The junction upper member 46 has an opening 46a, and a shoulder belt is withdrawn into the vehicle compartment 1 from a belt retractor (not illustrated) through the opening 46a.

The suspension housing reinforcement 44 disposed on the inward side of the wheel house inner 34 and the rear quarter panel inner 37 is joined to the wheel house inner 34 at its lower end, and its upper end is joined to an inward portion of the junction upper member 46 extending horizontally. An outward end, in the vehicle width direction, of the junction upper member 46 is joined to the rear quarter panel inner 37. Thus, a closed cross section 47 is formed among the members 46, 37, 34, 44.

The above-described package junctions 42, 43, suspension housing reinforcement 44, junction lower member 45, and junction upper member 46 constitute the wheel house reinforcement 35 which reinforces the rear wheel house 32.

As shown in FIG. 3, the bending portion 13b of the upper portion of the rear bulkhead 13 is joined and fixed to the junction upper member 46 which constitutes the wheel house reinforcement 35. Also, an anchor reinforcement 48 is attached to the U-shaped portion 13c of the rear bulkhead 13 so as to extend vertically.

Meanwhile, the damper SD which is coupled to the rear wheel 36 constitutes a rear suspension mechanism. Herein, a multi-link type of suspension may be applied as this rear suspension mechanism which includes an upper arm, a lower arm, a knuckle, and so on, not illustrated.

The above-described damper SD comprises, as shown in FIG. 3, a cylindrical damper support 49, an upper spring seat 50 which is joined to a lower end of the damper support 49, a lower spring seat 51, and a coil spring 52 which is arranged between the spring seats 50, 51.

A first gusset 61, a second gusset 62 and a third gusset 63 are provided at the suspension housing reinforcement 44 as gusset members to support the damper support 49 which projects upwardly from the suspension housing 40.

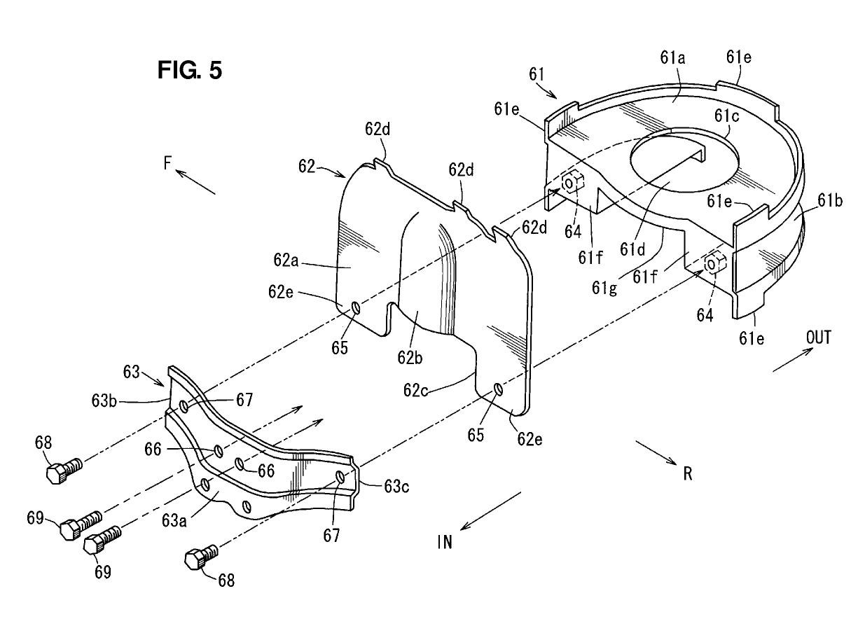

These gussets 61, 62, 63 will be described referring to FIG. 5. As shown in FIG. 5, the above-described first gusset 61 is a member which has a U-shaped cross section with upper and lower horizontal plate-shaped portions 61a, 61b. The centers of the horizontal plate-shaped portions 61a, 61b have through holes 61c, 61d for the damper support 49, and plural flanges 61e which are joined to the suspension housing reinforcement 44 are integrally with the horizontal plate-shaped portions 61a, 61b.

The first gusset 61 has attachment faces 61f, 61f at its position which faces to the roof storage space 14. Between these attachment faces 61f, 61f is formed a notch portion 61g, and to back faces of these 61f, 61f are previously welded nuts 64, 64. This first gusset 61 is attached to the suspension housing reinforcement 44 as shown in FIG. 3.

The second gusset 62, as shown in FIGS. 3 and 5, extends upwardly from the first gusset 61 and then is joined to the rear bulkhead 13 and the rear deck member 24 via the junction lower member 45. This second gusset 62 extending vertically comprises, as shown in FIG. 5, a gusset main plate 62a, a protruding portion 62b which is formed at a specified position of the gusset main plate 62a which corresponds to the damper support 49 so as to protrude toward the roof storage space 14, a notch portion 62c which is formed below the protruding portion 62b, and flanges 62d . . . which bend upwardly from an upper portion of the gusset main plate 62a. Bolt through holes 65, 65 are formed at attachment faces 62e, 62e which are formed away from each other in the vehicle longitudinal direction via the above-described notch portion 62c.

The third gusset 63 is arranged on the side of the roof storage space 14 relative to the second gusset 62, and formed in a substantial V shape such that its front portion 63b and its rear portion 63c are positioned slightly upwardly and outwardly, in the vehicle width direction, from the its middle portion 63a, as shown in FIG. 5. At the middle portion 63a of the third gusset 63 are formed two bolt through holes 66, 66, and at each of the front portion 63b and the rear portion 63c is formed a bolt through hole 67.

As shown in FIG. 3, the above-described first and second gussets 61, 62 are welded to the vehicle body previously, and after attaching the damper SD, the third gusset 63 is fixed to the gussets 61, 62 by fastening nuts 64, 64 to bolts 68, 68, and it is also fixed to a bracket 70 of the damper support 49 by bolts 69, 69. Further, as shown in FIG. 3, the upper end of the damper SD coupled to the rear wheel 36 is supported at the upper portion of the rear wheel house 32, and the above-described rollover protecting member 27 is arranged at a specified position which corresponds to a damper support portion 71 which comprises the first through third gussets 61-63 and the suspension housing reinforcement 44.

FIG. 6 is a partial enlarged sectional view of FIG. 3. The rollover protecting member 27 comprises a flange 27a and a taper cone portion 27b and is formed in a hollow shape. Plural nuts 53 are previously welded to a lower face of the junction upper member 46 and a lower face of the bending portion 13b at the upper portion of the rear bulkhead 13. Herein, by fastening bolts 54 to the plural nuts 53, the rollover protecting member 27 is fixed to the rear deck portion 26.

Herein, the vertical positional relationship between the above-described bolts 54 and nuts 53 may be reversed. That is, weld bolts may be fixed so as to extend upwardly from the junction upper member 46 and the rear bulkhead 13, and by fastening nuts to these weld bolts, the rollover protecting member 27 may be attached to the rear deck portion 26.

Further, as shown in FIGS. 1, 2 and 4, a bar 55 which has a closed cross section extending in the vehicle width direction is arranged so as to extend between the right and left rear quarter panel inners 37, 37, and a latch 56 which locks a lower portion of a front end of the front roof 4 in the storage state is attached to this bar 55. The latch 56 can be unlocked by an operation of a lever 58 at a console box 57 which is provided on the floor panel 6.

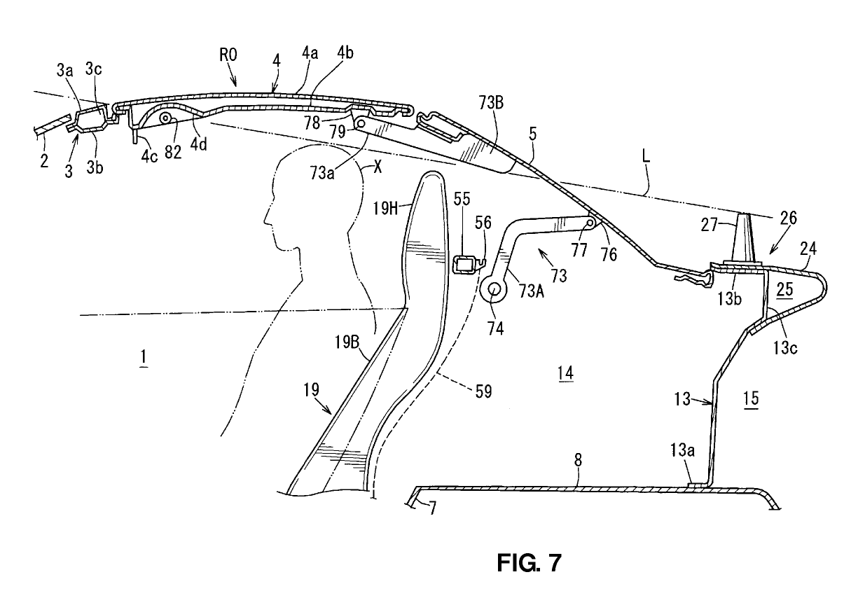

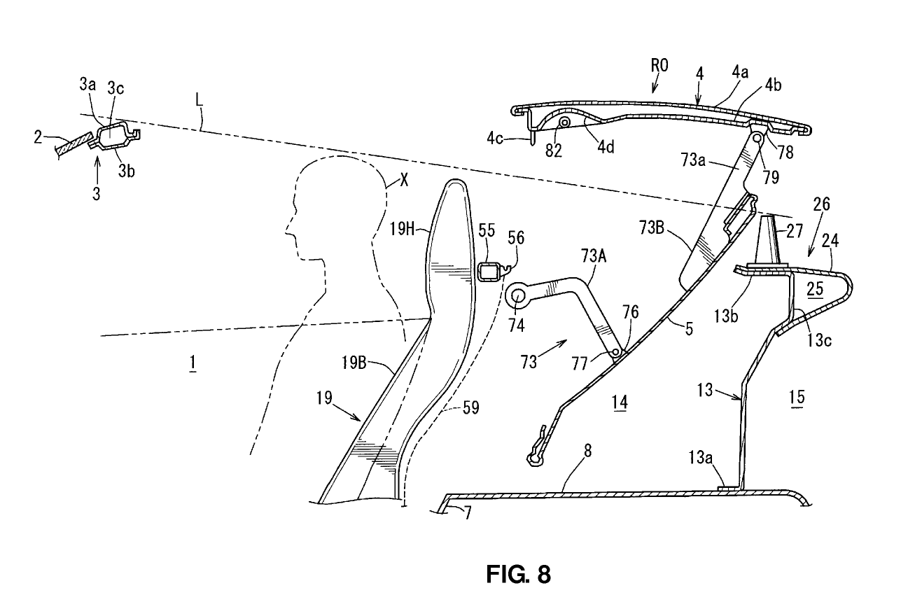

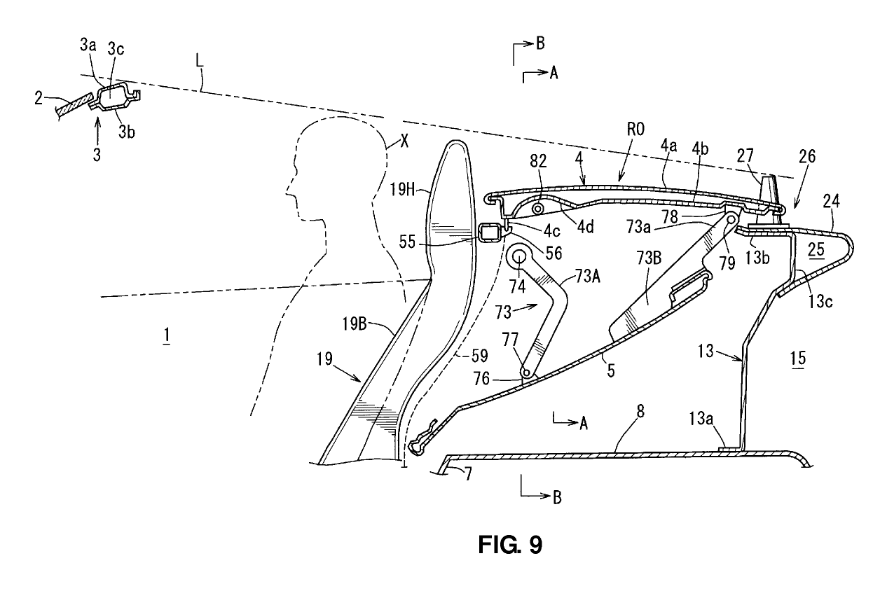

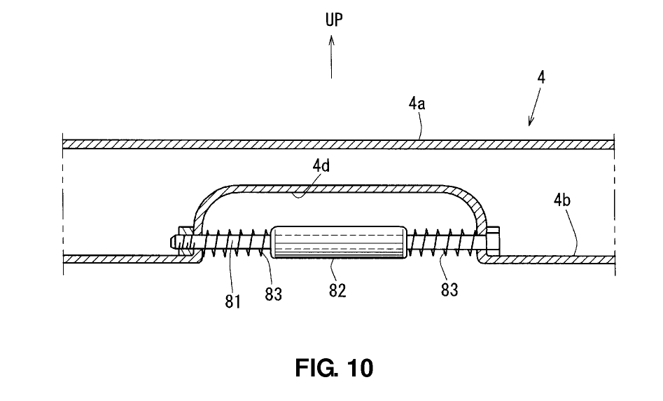

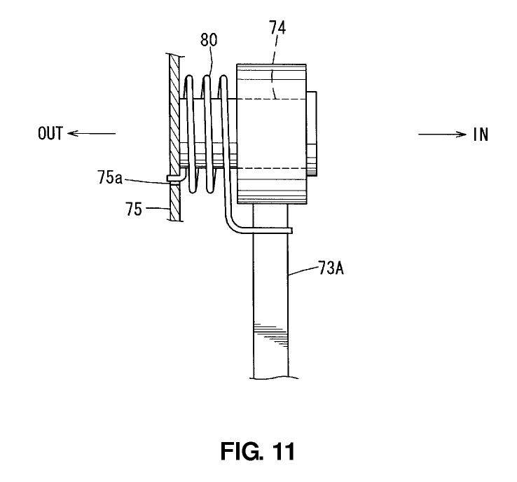

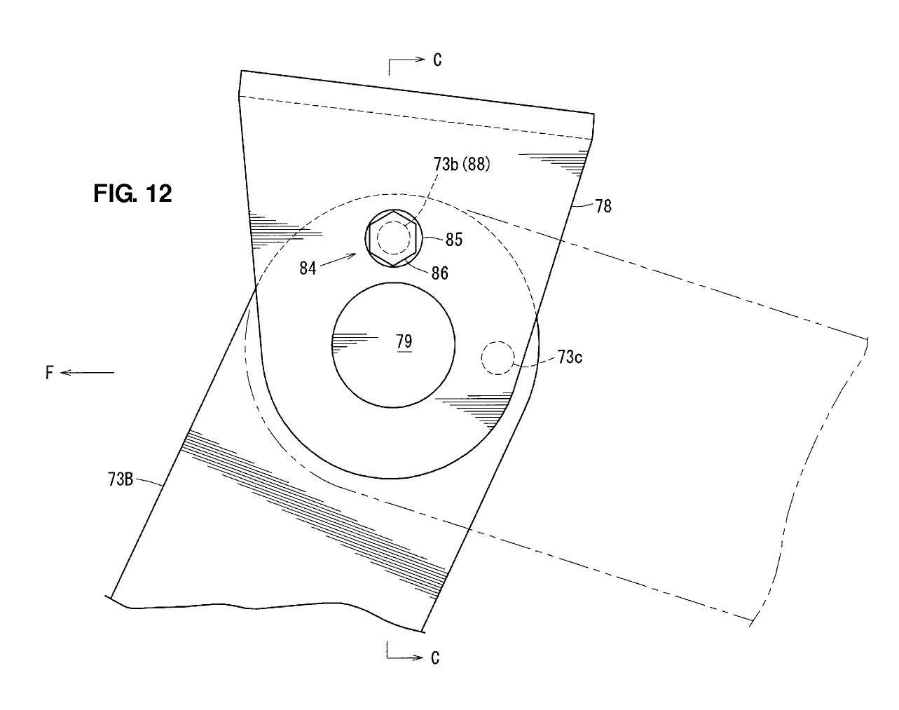

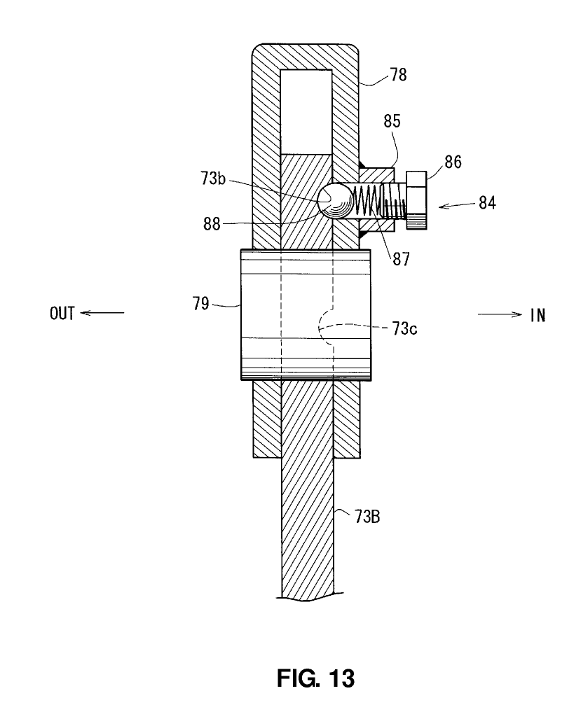

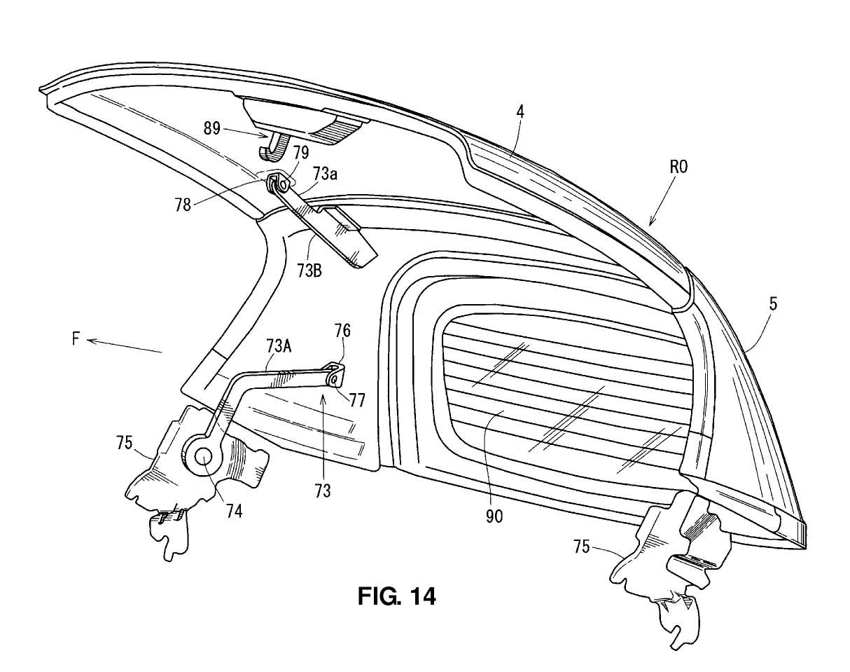

Next, the movable roof structure of a vehicle will be described referring to FIGS. 7 through 14. FIG. 7 is a side view in a roof-closed state (closing state). FIG. 8 is a side view in a roof-popped-up state. FIG. 9 is a side view in a roof-open state (open state). FIG. 10 is a partial sectional view taken along line A-A of FIG. 9. FIG. 11 is a partial sectional view taken along line B-B of FIG. 9. FIG. 12 is a partial enlarged side view showing a structure of a lock mechanism. FIG. 13 is a sectional view taken along line C-C of FIG. 12. FIG. 14 is a schematic perspective view showing the movable roof structure of a vehicle.

The above-described roof member RO is comprised of two split sub roof members, the front roof 4 and the rear roof 5, which are connected. In the first embodiment, both of the front and rear roofs 4, 5 are made of a board-shaped hard roof member, respectively. Further, in the present embodiment, means Z for allowing daylight to come into the vehicle compartment 1 is provided at least at part of the sub roof members. That is, at least part of the sub roof members, i.e., the above-described front roof 4, is made of a light-transparent material. Herein, since the front roof 4 is made of the board-shaped hard roof member, a semitransparent synthetic resin is used as the light-transparent material. That is, by making the front roof 4 of the semitransparent synthetic resin, the daylight is allowed to come into the vehicle compartment 1. Thus, the front roof 4 is made of the board-shaped hard roof member having a light transparency.

Herein, the above-described roof member RO is equipped with an open roof mechanism 73 which allows a manual operation with an opening operation from a state shown in FIG. 7 to a state shown in FIG. 9, and a closing operation from the state shown in FIG. 9 to the state shown in FIG. 7. Moreover, in the first embodiment, as shown in FIG. 9, when the roof member RO is open, the rear roof 5 is stored in the roof storage space 14 and the front roof 4 is horizontally positioned above the rear roof 5 so as to cover over the roof storage space 14.

The open roof mechanism 73 comprises a pair of links 73A and a pair of links 73B, and as shown in FIG. 14, a base portion of each of the links 73A is pivotally supported at the rear quarter panel inner 37 (see FIG. 4) via a support axis 74 and a bracket 75, and a free end portion of the link 73A is connected to a bracket 76 at the lower face of the rear roof 5 via a pin 77.

Further, the link 73B is fixed to a lower face of a front portion of the rear roof 5, and as shown in FIG. 7, the link 73B has an extension portion 73a which extends toward the front roof 4 from the rear roof 5. An end of the extension portion 73a is connected to a bracket 78 attached to a lower face of a rear portion of the front roof 4 via a pin 79.

While the open roof mechanism 73 with the links 73A, 73B comprises a pair of mechanisms arranged at both sides of the roof member RO as shown in FIG. 14, only the right-side open roof mechanism 73 is illustrated in the figure.

As shown in FIG. 11, a spring 80 is provided around the support axis 74 at the base portion of the link 73A. One end of the spring 80 is inserted into an engagement hole 75a of the bracket 75. The other end of the spring 80 contacts the link 73A. Thus, the spring 80 biases the rear roof 5 in the storage state shown in FIG. 9 in a direction of closing the rear roof 5. That is, the above-described spring 80 constitutes an assist mechanism to assist the closing-operational force by the passenger for closing the roof member RO.

As described above, since the closing-operational force is applied to the roof member RO in the storage state, at a lower portion of a front portion of an inner panel 4b of the front panel 4 is provided a striker 4c to engage with the above-described latch while the roof member RO is stored. Engaging the striker 4c with the latch 56 can hold (secure) the storage state of the front roof 4 and the rear roof 5 of the roof member RO in the storage state shown in FIG. 9.

When the lever 58 at the console box 57 (see FIG. 1) is operated for unlocking so that engaging of the striker 4c with the latch 56 is released via a wire 59, the roof member RO in the storage state shown in FIG. 9 is biased so as to be raised upwardly (popped up) to a specified position shown in FIG. 8 by a biasing force of the spring 80. Thereby, the manual operation of the front roof 4 by the passenger can be made easier.

As shown in FIG. 10 which is a partial sectional view taken along line A-A of FIG. 9, a concave portion 4d, which is wide and large enough to allow a driver's hand in, is formed at a middle portion, in the vehicle width direction, of the inner panel 4b of the front roof 4. A guide shaft 81 is provided so as to extend in the vehicle width direction between both side walls of the concave portion 4d. A grip 82 to be gripped by the driver's hand, which is a cylindrical member, is provided so as to be guided by the guide shaft 81 being inserted into a central hole of the gap 82. Further, a pair of springs 83, 83 is disposed on both sides of the grip 82 between the both side walls of the concave portion 4d.

Thus, since the grip 82 is movable along the guide shaft 81 relatively to the roof member RO substantially in the vehicle width direction (i.e., this structure corresponds to a “moving mechanism” in claims), the passenger can easily grip and operate or handle the grip 82 regardless of the position of the passenger's body or the passenger's own arm joint characteristics.

FIG. 12 shows a lock mechanism 84 between the link 73B and the gate-shaped bracket 78 at the lower portion of the rear portion of the front roof 4. The link 73B shown by solid lines in FIG. 12 matches the position of the link 73B shown in FIG. 8, and the link 73B shown by two-dotted broken lines in FIG. 12 matches the position of the link 73B shown in FIG. 7. The link 73B has two concave portions 73b, 73c so as to correspond to a move angle between the link position of FIG. 8 and the link position of FIG. 7. As shown in FIGS. 12 and 13, the bracket 78 has a ball-shaped lock member 88 which is selectively pressed into the above-described concave portions 73b, 73c with a basing force of a spring 87 by using a bolt 86 fastened into a screw hole of a cylindrical housing 85.

Accordingly, in the popped-up position of the roof member RO shown in FIG. 8, the lock member 88 is pressed into the concave portion 73b and its position is held. Further, in the closing position of the roof member RO shown in FIG. 7, the lock member 88 is pressed into the concave portion 73c and its position is held. In FIG. 14, reference numeral 89 denotes a top lock for detachably attaching the roof member RO to the front header 3, and reference numeral 90 denotes a back window. Herein, in these figures, an arrow F shows a vehicle forward direction, an arrow R shows a vehicle rearward direction, an arrow IN shows a vehicle inward direction, and an arrow OUT shows a vehicle outward direction, and an arrow UP shows a vehicle upward direction.

The present embodiment described above performs the following operations. In case the roof member RO in the closing state shown in FIG. 7 is changed to the open state shown in FIG. 9, when the front roof 4 is moved rearwardly by the passenger's manual operation after the lock of the roof member RO by the top lock 89 (see FIG. 14) is released, this rearward moving force is transmitted to the link 73A via the link 73B and the rear roof 5. Consequently, the link 73A rotates clockwise around the support axis 74, so that the rear roof 5 is moved rearwardly from the state shown in FIG. 7 to the state shown in FIG. 9.

As the front roof 4 is further moved rearwardly from the midway open state shown in FIG. 8, this rearward moving force is transmitted to the link 73A via the link 73B and the rear roof 5. Consequently, the link 73A further rotates clockwise around the support axis 74, so that the rear roof 5 is moved to a reverse state shown in FIG. 9 from the standing state in FIG. 8, and the front roof 4 is moved rearwardly and positioned above the rear roof 5 in the reverse state so as to cover horizontally over the roof storage space 14. In this case, the striker 4c of the front roof 4 engages with the latch 56 on the side of the vehicle body.

Reversely, in case the roof member RO in the storage state shown in FIG. 9 is changed to the closing state shown in FIG. 7, when the lever 58 (see FIG. 1) at the console box 67 is unlocked, the engagement of the striker 4c with the latch 56 is released via the wire 59. Consequently, the roof member RO rises up to the popped-up position shown in FIG. 8, receiving the biasing force of the spring 80 (see FIG. 11), and this position is held by the lock mechanism 84 (see FIGS. 12 and 13).

Herein, the popped-up position shown in FIG. 8 becomes a preferable height position for the passenger's operation, compared with the position of the front roof 4 shown in FIG. 9. Thus, when the roof member RO is manually operated so as to be moved in the closing direction, by griping the grip 82 of the front roof 4 shown in FIG. 8, the roof member RO is positioned to the closing state shown in FIG. 7.

Meanwhile, in case the vehicle with the roof member RO in the open state shown in FIG. 9 rolls over, the vehicle is supported by the front header 3 and the roll protecting member 27. Since the height of the line L which connects the upper end of the roll protecting member 27 and the upper end of the front header 3 is set to be higher than the upper end of the seatback 19B with the headrest 19H, the passenger X can be protected securely by the rollover protecting member 27 in the vehicle rollover.

The movable roof structure of a vehicle according to the first embodiment shown in FIGS. 1 through 14, comprises the roof member RO provided so as to be positioned in the closing state to cover over the upper part of the vehicle compartment 1 and the open state to open the upper part of the vehicle compartment 1, the roof member RO comprising the plural split sub roof members (see the front roof 4, the rear roof 5) which are connected, at least one of which is made of the board-shaped hard roof member, the roof member RO being stored in the storage portion (space 14) at the rear part of the vehicle compartment 1 in the state in which the sub roof members (the front roof 4, the rear roof 5) are folded when being in the open state, the operational member (see the grip 82) to be operated (gripped) by the passenger, the operational member (the grip 82) being provided at the specified position of the front-side member (see the front roof 4) of the sub roof members so as to transmit the opening-operational force or the closing-operation force by the passenger to the sub roof members for opening or closing the roof member RO, and the moving mechanism (see the guide shaft 81) provided to position the operational member (the grip 82) such that the operational member (the grip 82) is movable relatively to the roof member RO.

Herein, the means Z for allowing daylight to come into the vehicle compartment 1 is provided at least at part (the front roof 4 in the present embodiment) of the sub roof members (the front roof 4, the rear roof 5) (see FIG. 7). This means Z can be made from semitransparent synthetic resin in the first embodiment in which the sub roof member (the front roof 4) is made of the hard roof member.

According to the above-described structure, since the roof member RO which comprises the plural split sub roof members (the front roof 4, the rear roof 5) which are connected is provided and its opening or closing is manually operated (handled) by the passenger, the mechanism for opening or closing the roof member RO can be properly simple and light and also its operation and handling can be improved and its operational force can be decreased. Further, since the operational member (the grip 82) is provided so as to be operated by the passenger and movable relatively to the roof member RO, the operation and handling of the roof member RO by the passenger can be further improved. That is, since the grip 82 is movable along the guide shaft 81 relatively to the roof member RO substantially in the vehicle width direction, the passenger can easily grip and operate or handle the grip 82 regardless of the position of the passenger's body or the passenger's own arm joint characteristics.

Further, the roof member RO comprises the two sub roof members (the front roof 4, the rear roof 5) which are connected to each other (see FIG. 7). Thereby, since the roof member RO is comprised of two split members, the structures of the roof member RO and the open roof mechanism 73 can be simpler and lighter and the storage space of the roof member RO can be simplified accordingly.

Moreover, the roof member RO comprises at least the front roof member (front roof 4) and the rear roof member (rear roof 5), and both of the front and rear roof members (front and rear roofs 4, 5) are made of the hard roof member (see FIG. 7). Thereby, since both of the front and rear roof members (front and rear roofs 4, 5) are made of the hard roof member, the antitheft (burglarproof), thereby the safety of the vehicle can be improved and also the nice-looking car design can be secured.

Further, since the means Z for allowing daylight to come into the vehicle compartment 1 is provided at least at part of the sub roof members (the front roof 4 in the present embodiment), better lighting can provide the comfortable circumstances in the vehicle compartment 1.

At least part of the sub roof members (front roof 4) is made of the light-transparent material (semitransparent synthetic resin) (see FIG. 7). Thereby, the better lighting can be achieved with a simple structure without forming any window at the sub roof members (front roof 4) or conducting any design changing.

In addition, the roof member RO comprises at least the front roof 4 and the rear roof 5, and the front roof 4 is made of the light-transparent hard roof member (see FIG. 7). Thereby, since the front roof 4, which contributes the safety the most, is made of the hard roof member, the vehicle is properly superior in antitheft. Further, since the front roof 4 has the light transparency, the better lighting is available, so that the comfortable circumstances in the vehicle compartment 1 can be provided.

The above-described movable roof structure of a vehicle further comprises the assist mechanism (see the spring 80) to assist an operational force by the passenger. Thereby, since the operational force of the manual operation by the passenger is assisted (helped) by the assist mechanism (spring 80), decreasing the operational force which may be necessary for the manual operation of the roof member RO can be achieved, so that the handling can be further improved. Herein, the above-descried assist mechanism (spring 80) assists (helps) the closing-operational force by the passenger for closing the roof member. Thereby, the operational force of closing the roof member RO can be decreased, so that the closing handling can be further improved. Moreover, since the roof member RO in the storage state shown in FIG. 9 is biased so as to be raised upwardly (popped up) to the specified position shown in FIG. 8 by the biasing force of the spring 80, the manual operation of the front roof 4 by the passenger can be made easier.

### Embodiment 2

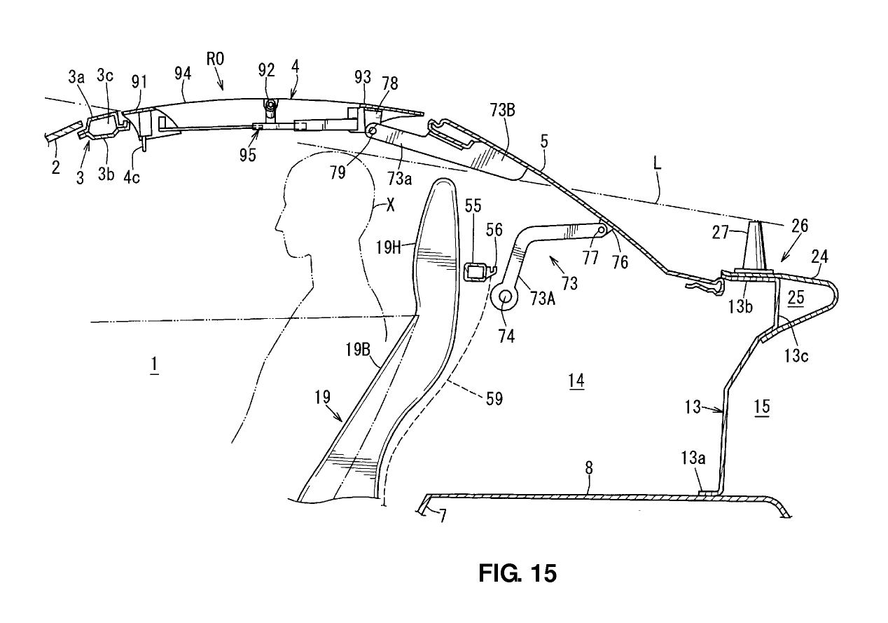

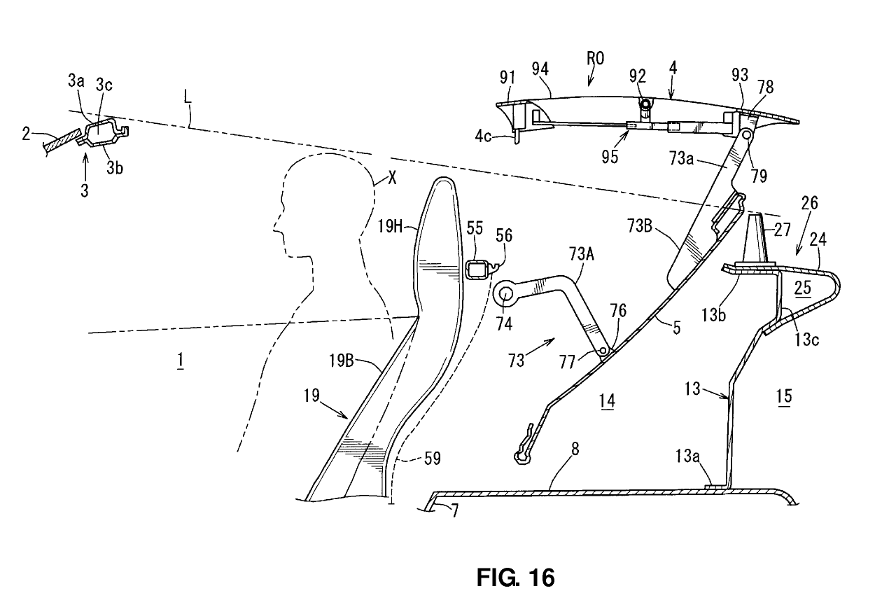

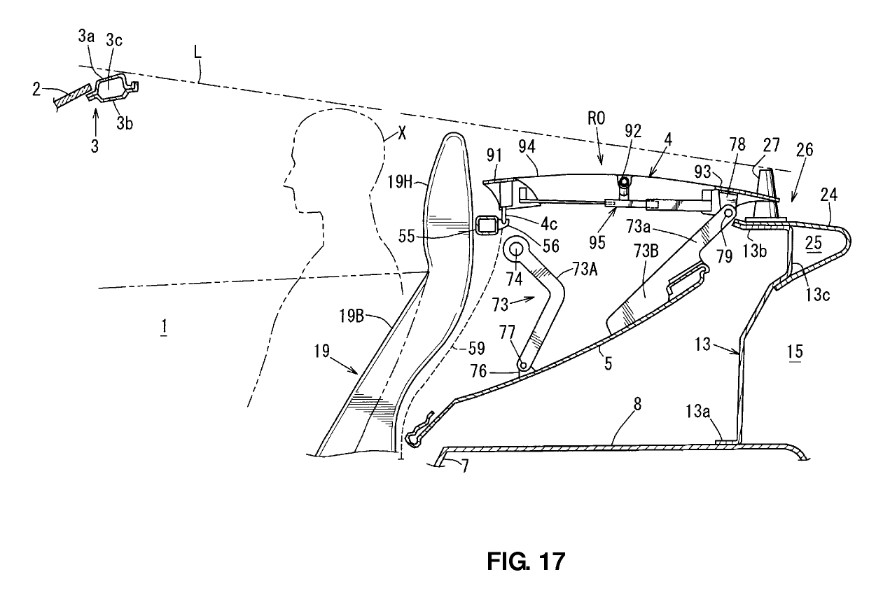

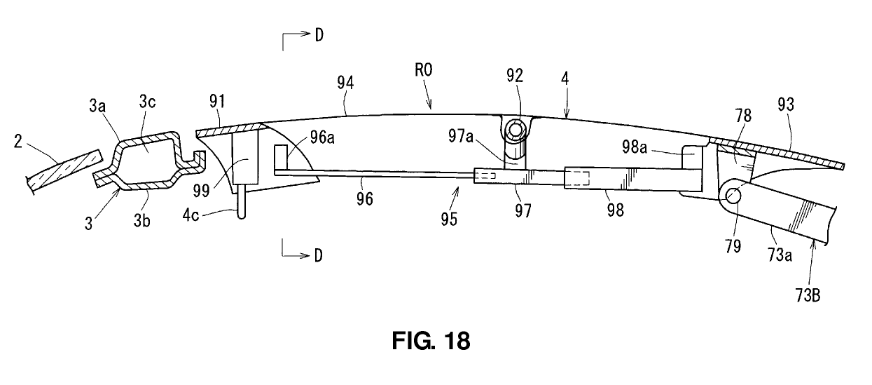

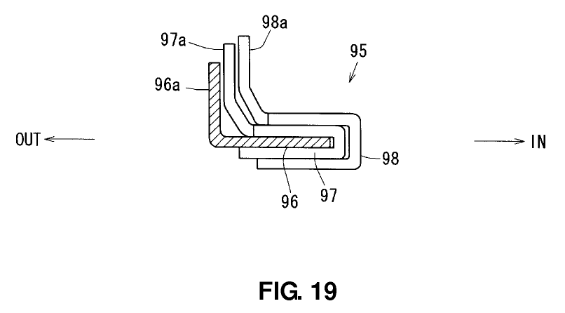

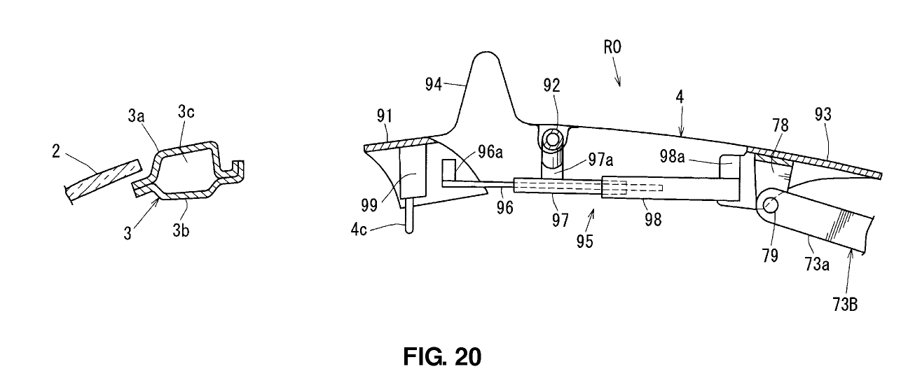

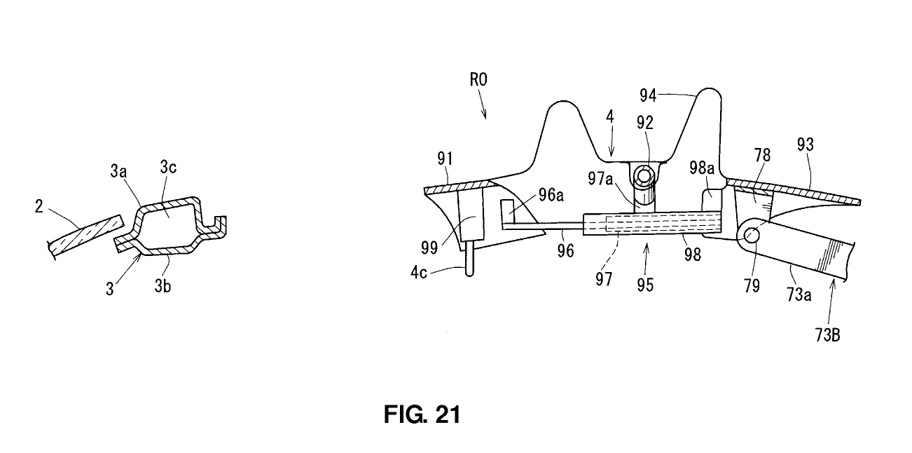

FIGS. 15 through 21 show a movable roof structure of a vehicle according to a second embodiment of the present invention. FIG. 15 is a side view in a closing state of the roof member. FIG. 16 is a side view in a roof-popped-up state of the roof member. FIG. 17 is a side view in a roof-open state of the roof member. FIG. 18 is a partial enlarged sectional view of FIG. 15. FIG. 19 is a partial sectional view taken along line D-D of FIG. 18. FIG. 20 is a side view showing a partially-open state of a front roof. FIG. 21 is a side view showing a state in which the front roof is opened more. The same components are denoted by the same reference characters.

While the both of the front and rear roofs 4, 5 are made of the board-shaped hard roof member in the above-described first embodiment, in the second embodiment shown in FIGS. 15 through 21, the rear roof 5 is made of the board-shaped hard roof member, whereas the front roof 4 is made of a flexible roof member, i.e., a so-called soft roof.

Additionally, the means Z for allowing daylight to come into the vehicle compartment 1 is provided at the front roof 4 as part of the sub roof members in the second embodiment as well. However, since the front roof 4 is made of the flexible roof member in this embodiment, a top 94, which will be described below, of this flexible roof member is made of a light-transparent material. A white canvas is used as this light-transparent material.

Thus, the front roof 4 comprises, as shown in FIG. 18, a front forming member 91 which is made of an arch-shaped plate, a middle forming member 92 which is made of an arch-shaped pipe, a rear forming member 93 which is made of an arch-shaped plate, and the top 94 which is made of clothes (white canvas) and stretched over the forming members 91, 92, 93.

A pair of rail mechanisms 95 which can expand and contract in the vehicle longitudinal direction is provided at both sides of a lower portion of the front roof 4 for opening or closing the top 94. This rail mechanism 95 comprises, as shown in FIGS. 18 and 19, a front rail 96, a middle rail 97, and a rear rail 98. The rear rail 98 holds the middle rail 97 so that the middle rail 97 can slide longitudinally, and the middle rail 97 holds the front rail 96 so that the front rail 96 can slide longitudinally.

An attachment piece 96a is integrally formed at a front portion of the front rail 96, and this attachment piece 96a is fixed to a curve lower portion of the front forming member 91. An attachment piece 97a is integrally formed at a middle portion of the middle rail 97, and this attachment piece 97a is fixed to a curve lower portion of the middle forming member 92. An attachment piece 98a is integrally formed at a rear portion of the rear rail 98, and this attachment piece 98a is fixed to a curve lower portion of the rear forming member 93.

While the pair of rail mechanisms 95 is provided at the both sides of the lower portion of the front roof 4, only the right-side one is illustrated. Herein, the above-described rear rail 93 is a fixed one, and the other two rails 96, 97 are movable ones. Accordingly, the flexible-member made front roof 4 can be partially opened by the passenger's manual operation to any state position which is shown in FIG. 20 or FIG. 21. That is, the present embodiment can provide a partially-open mode in which the roof member RO is partially open and held.

Meanwhile, the striker 4c is attached to a lower position of the front forming member 91 via a bracket 99 as shown in FIGS. 18, 20 and 21. The grip 82 and others shown in FIG. 10, the spring 80 (the assist mechanism) shown in FIG. 11, and the lock mechanism 84 shown in FIG. 13 are applied in the second embodiment as well as the first embodiment, specific illustrations and descriptions of which are simply omitted here.

According to the movable roof structure of a vehicle of the second embodiment shown in FIGS. 15 through 21, the roof member RO comprises at least the front roof 4 and the rear roof 5 which are connected, and the rear roof 5 is made of the hard roof member (see FIG. 15). In other words, the rear roof 5 is made of the hard roof member, whereas the front roof 4 is made of the flexible and light-transparent material so as to be the so-called soft top.

Thereby, since the rear roof 5 is made of the hard roof member, the appearance can be improved in case a rear window (back window 90) is attached to the rear roof 5 and its structure can be better as well. Moreover, the light weight can be achieved, compared with a case in which the whole of roof member RO is made of the hard roof member entirely. Further, since the front roof 4 is made of the light-transparent material (white canvas), the better lighting is available in accordance with the passenger's request, thereby further improve the comfortable circumstances in the vehicle compartment 1.

Further, since the partially-open mode in which the roof member RO is partially open and held as described above is provided, the open positions of the roof member RO are selectable, so that the passenger can be provided with comfortable feelings. Herein, the roof member RO can take the full-closing position, the partially-open position, and the full-open position. Also, since the open roof mechanism stops moving of the roof member RO in the middle of opening or closing operation of the roof member RO, the passenger's having the comfortable feelings can be further improved. Herein, since this stopping of moving the roof member RO is conducted at any position, adjusting the amount of outside-air induction or lighting is available in accordance with the passenger's request. Moreover, since the front roof 4 is movable in the vehicle longitudinal direction, the partially-open mode can be secured when the front roof 4 is moved, so that both of the outside-air induction or the ventilation of the vehicle compartment 1 and lighting adjustment can be achieved.

The other structures, operations and effects of the second embodiment shown in FIGS. 15 through 21 are substantially the same as those of the first embodiment. Therefore, the same components are denoted by the same reference characters in FIGS. 15 through 21, specific descriptions of which are omitted here. In place of the second embodiment, the front roof 4 may be made of the hard roof member, and the rear roof 5 may be made of the flexible member. Further, in case the means Z for allowing daylight to come into the vehicle compartment 1 is provided at the hard roof member, it may be configured to adjust the amount of daylight allowed to come in by using a liquid light-adjusting glass.

Further, alternative examples which can provide the above-described partially-open mode like the second embodiment will be described as third and fourth embodiments.

### Embodiment 3

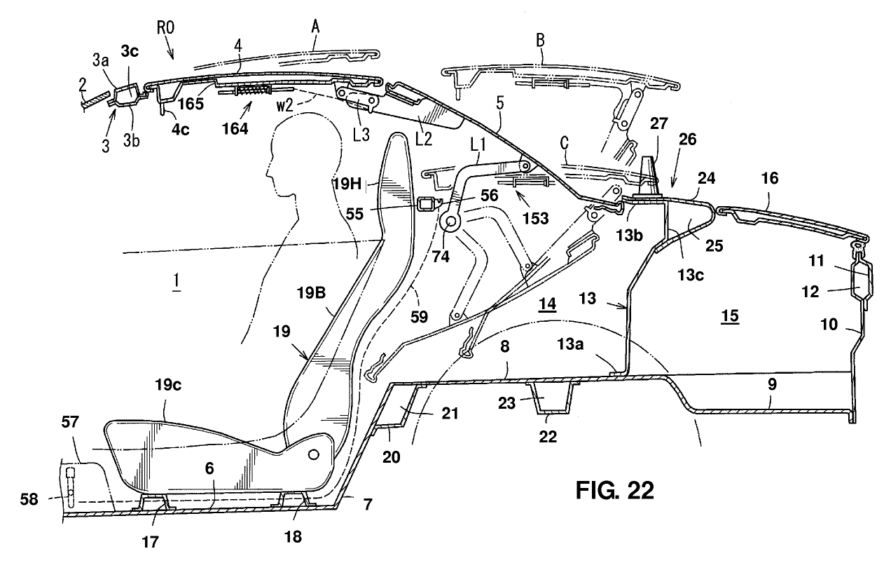

A third embodiment of the present invention will be described referring to FIGS. 22 through 27. The same components as those of the above-described first embodiment are denoted by the same reference characters, specific descriptions of which are omitted here. Further the grip 82 and others shown in FIG. 10, the spring 80 (the assist mechanism) shown in FIG. 11, and the lock mechanism 84 shown in FIG. 13 are applied in the third embodiment as well as the first embodiment, specific illustrations and descriptions of which are simply omitted here.

In FIG. 22, the closing state of the front and rear roofs 4, 5 is illustrated by solid lines, a partially-open mode of the roof member RO is illustrated by two-dotted broken lines A, a midway opening state (popped-up state) of the front and rear roofs 4, 5 is illustrated by two-dotted broken lines B, and a storage state of those in the roof storage space 14 is illustrated by two-dotted broken lines C.

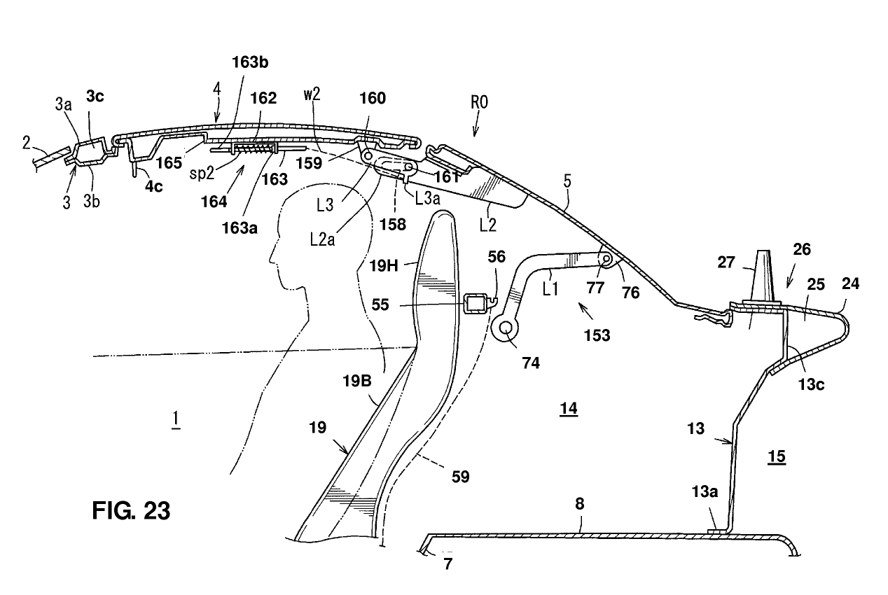

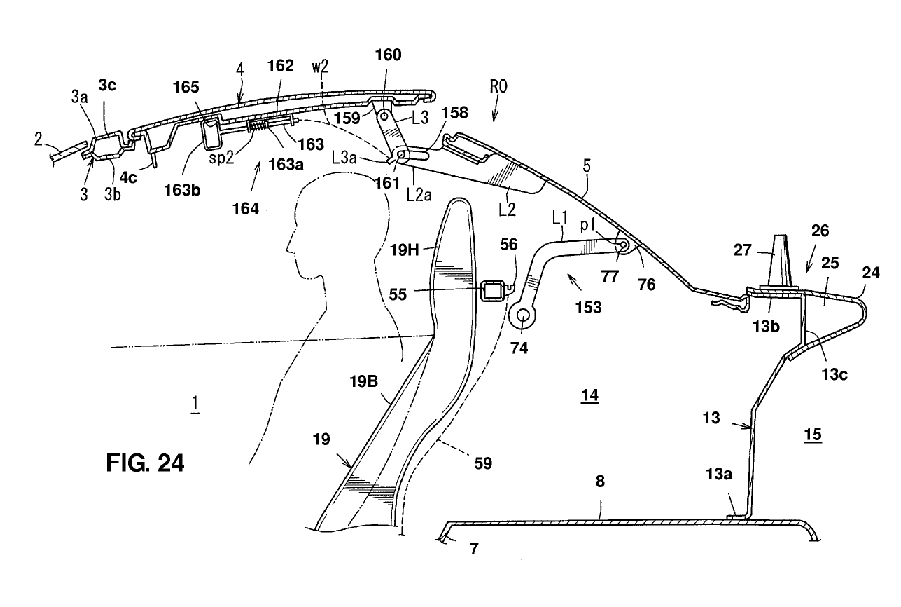

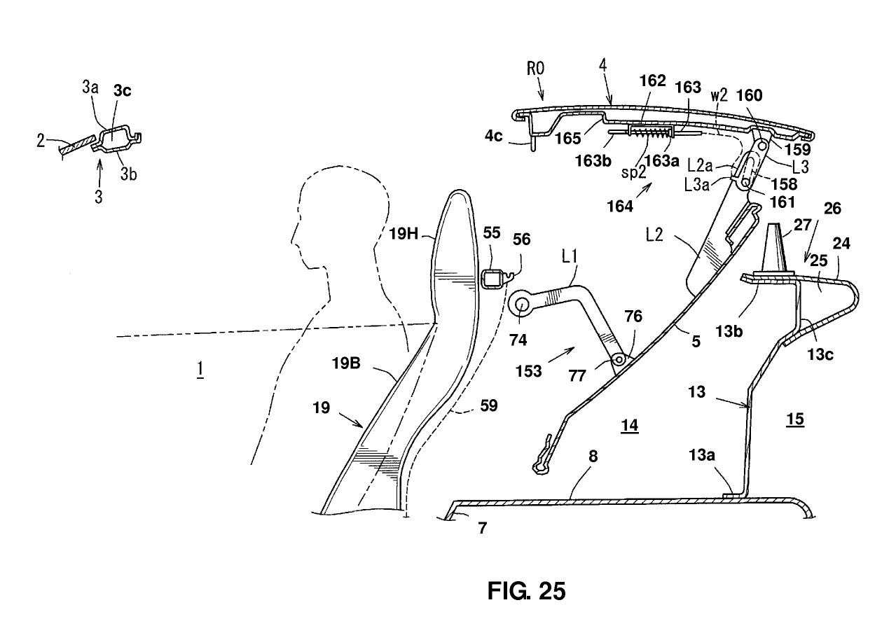

In the third embodiment, both of the front and rear roofs 4, 5 are made of the board-shaped hard roof member, and there is provided an open roof mechanism 153 which allows a manual operation with an opening operation from a state shown in FIG. 23 to a state shown in FIG. 25, and a closing operation from the state shown in FIG. 25 to the state shown in FIG. 23. This open roof mechanism 153 has another type of partially-open mode in which part of the roof member RO is opened and held as shown in FIG. 24.

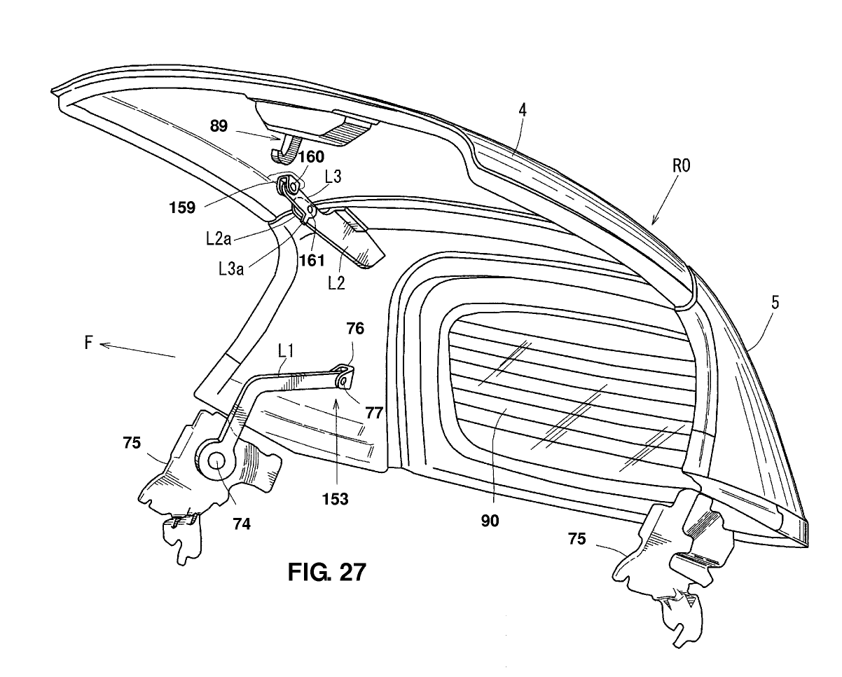

Thus, the open roof mechanism 153 comprises a link L1, another link L2, and a sub link L3. As shown in FIG. 27, a base portion of the link L1 is pivotally supported at the rear quarter panel 37 on the vehicle-body side via the support axis 74 and the bracket 75, and a free end portion of the link L1 is connected to the bracket 76 at the lower face of the rear roof 5 via the pin 77. Further, the link L2 is fixed to a lower face of a front portion of the rear roof 5, and as shown in FIG. 23, the link L2 has an extension portion L2a which extends toward the front roof 4 from the rear roof 5. A slot 158 is formed at the extension portion L2a so as to extend substantially in the vehicle longitudinal direction. Moreover, the sub link L3 is connected to a bracket 159 fixed to a lower face of a rear portion of the front roof 4 via a pin 160, and this sub link L3 has a pin 161 to be inserted in the above-described slot 158 at its rear end. Additionally, a projecting piece L3a is integrally formed with a specified portion of the sub link L3 near the pin 161, and a rear end of a rod 163 which is formed at a lower face of a middle portion of the front roof 4 via a bracket 162 and the above-described projecting piece L3a are interconnected via a wire w2. Thus, a tilt-up mechanism 164 as an open mechanism is provided.

Herein, a spring retainer 163a is integrally formed with the rod 163 at a specified position located in a gate-shaped bracket 162. A spring sp2 is arranged between a front piece of the bracket 162 and the spring retainer 163a. Further, at a front portion of the rod 163 is formed a loop-shaped grip 163b as shown in FIG. 24, and a concave engagement portion 165 for an engagement with the above-described grip 163b is formed at a specified portion of the roof inner panel of the front roof 4.

Herein, when the rod 163 is pulled forwardly against a biasing force of the spring sp2 from the fully closed state of the roof member RO shown in FIG. 23 and then this rod 163 is rotated by 90° so as to have the grip 163b engage with the concave engagement portion 165, the pin 161 of the sub link L3 moves forwardly along the slot 158 of the link L2, so that the sub link L3 takes its standing state as shown in FIG. 24. Thus, the rear portion of the front roof 4 rises (tilts) up so that the front roof 4 partially opens. That is, the above-described tilt-up mechanism 164 is a mechanism (opening mechanism) to vertically move the front roof 4 as part of the roof member RO. Herein, a return spring (not illustrated) to return the sub link L3 to its normal position shown in FIG. 23 is provided between the above-described bracket 159 and the sub link L3.

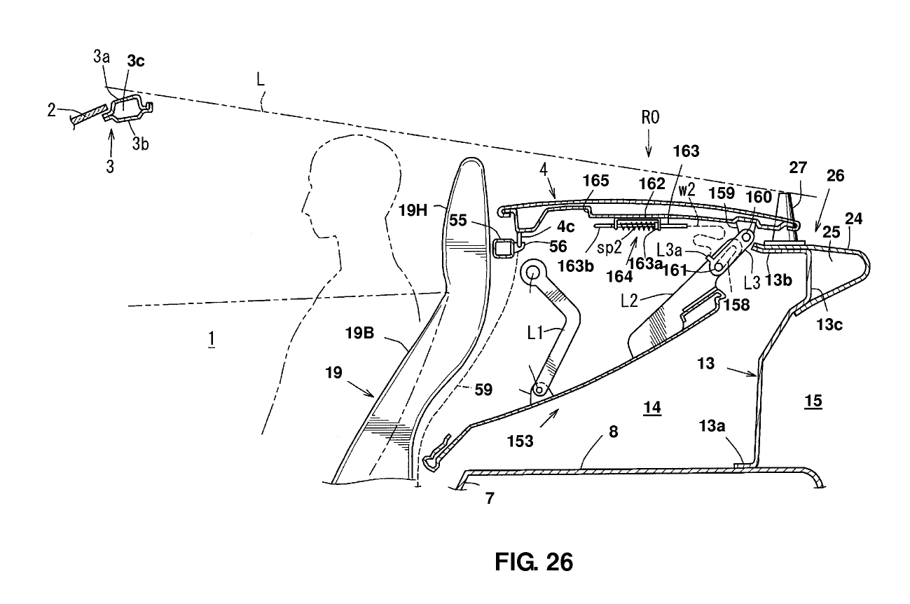

Hereinafter, the operation of the present embodiment described above will be described. In case the roof member RO in the closing state shown in FIG. 23 is changed to its open state shown in FIG. 26, when the front roof 4 is moved rearwardly through the driver's manual operation after releasing the lock of the roof member RO by the top lock 89 (see FIG. 27), this rearward moving force is transmitted to the link L1 via the links L3, L2 and the rear roof 5. The link L1 rotates clockwise around the support axis 74, so that the rear roof 5 is moved rearwardly from the state shown in FIG. 23 to the state shown in FIG. 25.

As the front roof 4 is further moved rearwardly from the midway open state shown in FIG. 24, this rearward moving force is transmitted to the link L1 via the links L3, L2 and the rear roof 5. Consequently, the link L1 further rotates clockwise around the support axis 74, so that the rear roof 5 is moved to a reverse state shown in FIG. 25 from the standing state in FIG. 24, and the front roof 4 is moved rearwardly and positioned above the rear roof 5 in the reverse state so as to cover horizontally over the roof storage space 14. In this case, the striker 4c of the front roof 4 engages with the latch 56 on the side of the vehicle body.

Reversely, in case the roof member RO in the storage state shown in FIG. 25 is changed to the closing state shown in FIG. 23, when the lever 58 (see FIG. 22) at the console box 67 is unlocked, the engagement of the striker 4c with the latch 56 is released via the wire 59. Consequently, the roof member RO rises up to the popped-up position shown in FIG. 24, receiving the biasing force of the spring 80, and this position is held by the lock mechanism 84.

Herein, the popped-up position shown in FIG. 25 becomes a preferable height position for the passenger's operation, compared with the position of the front roof 4 shown in FIG. 26. Thus, when the roof member RO is manually operated so as to be moved in the closing direction, the roof member RO is positioned to the closing state shown in FIG. 23.

Meanwhile, when after the rod 163 is pulled forwardly against the biasing force of the spring sp2 in the full closing state of the roof member RO shown in FIG. 23, it is operated to turn by 90° so that the grip 163b can engage with the engagement portion 165, the pin 161 of the sub link L3 moves forwardly along the slot 158 of the link L2 as shown in FIG. 24, so that the sub link L3 takes its standing state. Consequently, the front roof 4 tilts up around its front end top lock 89 (see FIG. 27) so that its rear portion tilts up and the front roof 4 opens partially. That is, the open roof mechanism 153 including the tilt-up mechanism 164 is configured so that moving of the roof member RO is stopped in the middle of opening the roof member RO. Thus, the present embodiment can provide another type of partially-open mode (see FIG. 24) in which the rear portion of the front roof 4 tilts up and open partially.

According to the present embodiment shown in FIGS. 22 through 27, the movable roof structure of a vehicle comprises the open roof mechanism 153 to provide the partially-open mode (see FIG. 24) in which the roof member RO is partially open and held (see FIGS. 23 and 24). Thereby, the open positions of the roof member RO are selectable, so that the passenger can be provided with comfortable feelings. Herein, the roof member RO can take the full-closing position (see FIG. 23), partially-open position (see FIG. 24), and full-open position (see FIG. 26).

Further, the open roof mechanism 153 stops moving of the roof member RO in the middle of opening or closing operation of the roof member RO (see FIG. 24). Thereby, the passenger's having the comfortable feelings can be further improved. Moreover, the movable roof structure of a vehicle comprises the opening mechanism (the tilt-up mechanism 164) to vertically move at least part of the roof member RO (the front roof 4 in the present embodiment) (see FIG. 24). Thereby, ventilation of the vehicle compartment can be improved.

### Embodiment 4

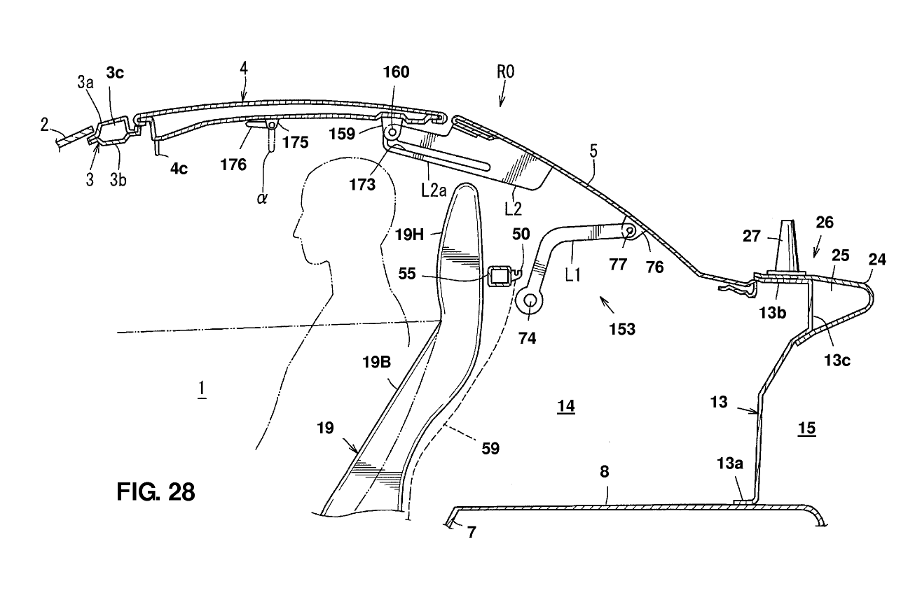

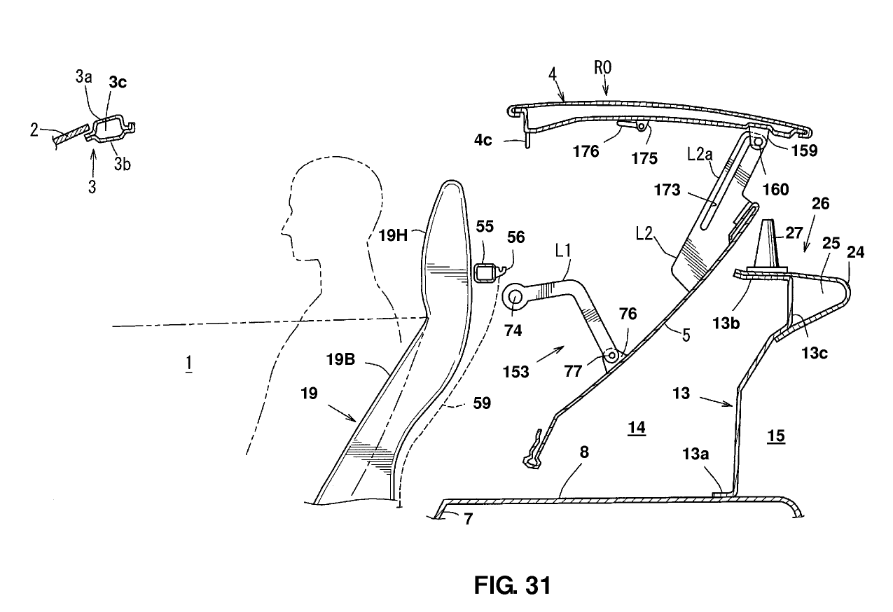

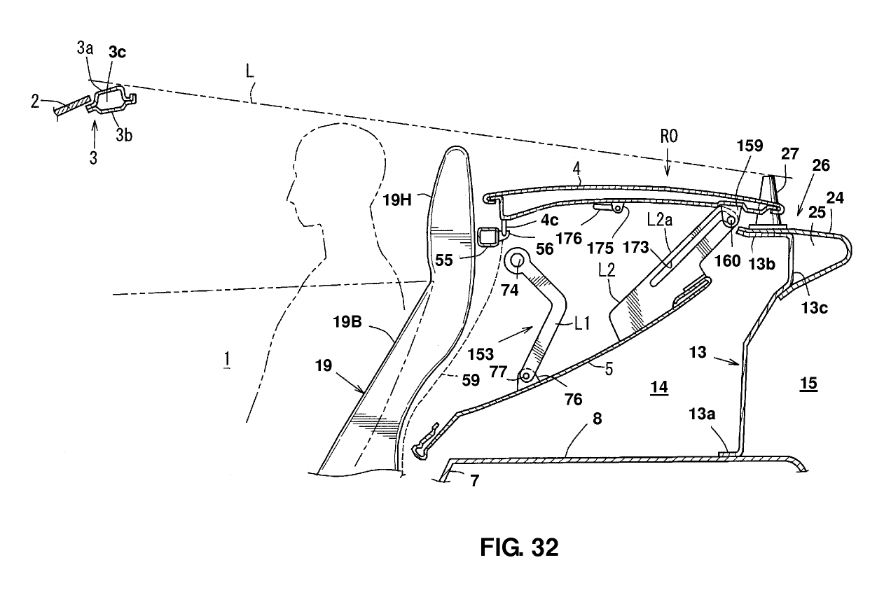

A fourth embodiment of the present invention will be described referring to FIGS. 28 through 32. The same components as those of the above-described first embodiment are denoted by the same reference characters, specific descriptions of which are omitted here. Further the grip 82 and others shown in FIG. 10, the spring 80 (the assist mechanism) shown in FIG. 11, and the lock mechanism 84 shown in FIG. 13 are applied in the fourth embodiment as well as the first embodiment, specific illustrations and descriptions of which are simply omitted here.

While the partially-open mode is provided by the tilt-up mechanism 64 in the above-described third embodiment, according to the fourth embodiment the front roof 4, as one of the sub roof members, is movable in the vehicle longitudinal direction, so that when the front roof 4 is moved rearwardly from the full-closing state, the rear portion of the front roof 4 moves below the front portion of the rear roof 5 so as to provide further another type of partially-open mode (a so-called half-open mode).

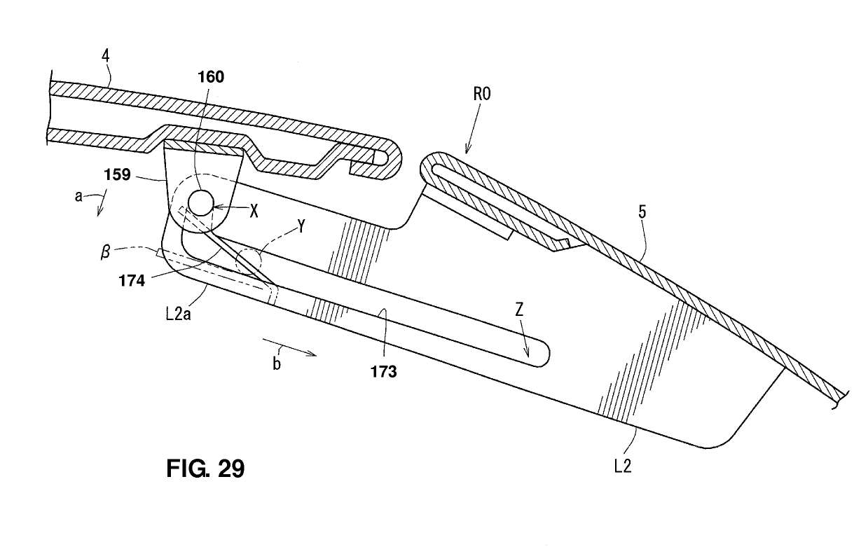

Accordingly, in the fourth embodiment, as shown in FIGS. 28 and 29, the extension portion L2a of the link L2 at the rear roof 5 has a hook-shaped slot 173 which allows the front roof 4 to move longitudinally. Meanwhile, a bracket 159 attached to the rear lower face of the front roof 4 is formed a reverse-L shape in an elevation view, this bracket 159 is arranged on the inward side of the link L2, and a pin 160 provided at the bracket 159 is inserted into the above-described slot 173.

Further, a plate spring 174 (biasing member) is provided on the outward side, in the vehicle width direction, of the extension portion L2a of the link L2. This plate spring 174 functions to return the above-described pin 160 to its original position X from a stroke-end position Z by way of a position Y when the front roof 4 is moved to the full-closing position after the pin 160 is moved to its stoke-end position Z by way of its positions X, Y. Thus, the plate spring 174 biases the pin 160 projecting outwardly from the slot 173 toward the position X shown in FIG. 29.

Additionally, a grip 176 is attached to the lower position of the middle portion of the front roof 4 via a bracket 175 as shown in FIG. 28. This grip 176 is biased in a direction so that it is positioned along the lower face of the front roof 4, and when used, this grip 176 is rotated to a position α illustrated by a broken line in this figure.

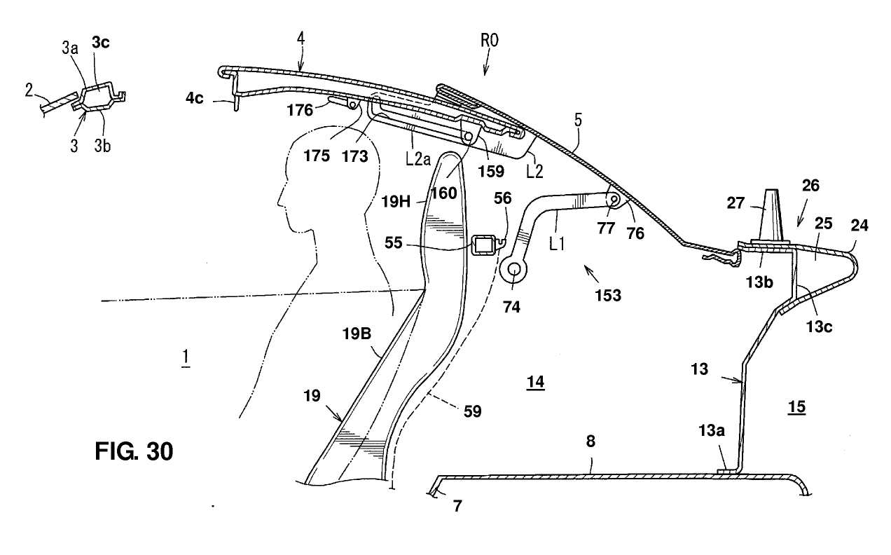

FIG. 28 shows the full-closing state of the roof member RO, and in order to make further another type of partially-open mode (so-called half-open mode) shown in FIG. 30 from this full-closing state, the door lock 89 (see FIG. 27) is unlocked and then the grip 176 is rotated from the position illustrated by the solid line to the position α illustrated by the broken line in FIG. 28. Next, by gripping the grip 76, the front roof 4 and the pin 160 are moved downwardly in an arrow a direction, and then moved rearwardly in an arrow b direction in FIG. 29. Thereby, the pin 160 moves along the slot 173 from its original position X to its stroke end position Z by way of the middle position Y. Accordingly, the rear portion of the front roof 4 slides below the front portion of the rear roof 5, so that further another type of partially-open mode, i.e., the so-called half-open mode, shown in FIG. 30 can be provided.

Meanwhile, in case the front roof 4 in the partially-open mode shown in FIG. 30 is returned to the full-closing state shown in FIG. 28, the pin 160 moves in the opposite direction to the above-described direction, and then when the pin 160 moves to the middle position Y from the stroke end position Z, the plate spring 174 moves to a position β shown by a two-dotted broken line, and thereby pushes the pin 160 up to the original position X with the spring's biasing force. Accordingly, there occurs no substantial gap (step) between the rear end of the font roof 4 and the front end of the rear roof 5 in the full-closing state of the roof member RO as shown in FIGS. 28 and 29, so that an appropriate design and a sealing function can be improved.

According to the fourth embodiment shown in FIGS. 28 through 32, one of the sub roof members (the front roof 4) is movable in the vehicle longitudinal direction (see FIGS. 28 through 30). Thereby, the partially-open mode (see FIG. 30) can be secured when the sub roof member (front roof 4) is moved, so that both of the outside-air induction or the ventilation of the vehicle compartment 1 and lighting adjustment can be achieved.

The present should not be limited to the above-described embodiments, and any other modifications or improvements can be applied within the scope of a spirit of the present invention.

What is claimed is:

1. A movable roof structure of a vehicle, comprising:
a roof member provided so as to be positioned in a closing state to cover over an upper part of a vehicle compartment and an open state to open the upper part of the vehicle compartment, the roof member comprising a plurality of split sub roof members which are connected, at least one of which is made of a board-shaped hard roof member; the roof member being stored in a storage portion at a rear part of the vehicle compartment in a state in which the sub roof members are folded when being in the open state;
an operational member to be operated by a passenger, the operational member being provided at a specified position of a front-side member of the sub roof members so as to transmit an opening-operational force or a closing-operation force by the passenger to the sub roof members for opening or closing the roof member; and
a moving mechanism provided to position the operational member such that the operational member is movable relatively to the roof member.

2. The movable roof structure of a vehicle of claim 1, wherein said moving mechanism positions the operational member such that the operational member is movable relatively to the roof member substantially in a vehicle width direction.

3. The movable roof structure of a vehicle of claim 2, wherein said operational member comprises a cylindrical member, and said moving mechanism comprises a shaft member which is fixed at the front-side member of the sub roof members so as to extend substantially in the vehicle width direction and guide the cylindrical member by being inserted into a central hole of the cylindrical member.

4. The movable roof structure of a vehicle of claim 1, wherein said roof member comprises two sub roof members which are connected to each other.

5. The movable roof structure of a vehicle of claim 1, wherein said roof member comprises at least a front roof member and a rear roof member, and both of the front and rear roof members are made of a hard roof member.

6. The movable roof structure of a vehicle of claim 1, wherein said roof member comprises at least a front roof member and a rear roof member, and the front roof member is made of a hard roof member.

7. The movable roof structure of a vehicle of claim 1, wherein said roof member comprises at least a front roof member and a rear roof member, and the rear roof member is made of a hard roof member.

8. The movable roof structure of a vehicle of claim 1, wherein means for allowing daylight to come into the vehicle compartment is provided at least at part of said sub roof members.

9. The movable roof structure of a vehicle of claim 8, wherein at least part of said sub roof members is made of a light-transparent material.

10. The movable roof structure of a vehicle of claim 8, wherein said roof member comprises at least a front roof member and a rear roof member, and the front roof member is made of a flexible and light-transparent material.

11. The movable roof structure of a vehicle of claim 8, wherein said roof member comprises at least a front roof member and a rear roof member, and the front roof member is made of a light-transparent hard roof member.

12. The movable roof structure of a vehicle of claim 1, further comprising an assist mechanism to assist an operational force by the passenger.

13. The movable roof structure of a vehicle of claim 12, wherein said assist mechanism assists the closing-operational force by the passenger for closing the roof member.

14. The movable roof structure of a vehicle of claim 13, wherein said assist mechanism comprises a biasing means for assisting the closing-operational force by the passenger for closing the roof member.

15. The movable roof structure of a vehicle of claim 1, further comprising an open roof mechanism to provide a partially-open mode in which said roof member is partially open and held.

16. The movable roof structure of a vehicle of claim 15, wherein said open roof mechanism stops moving of said roof member in the middle of opening or closing operation of the roof member.

17. The movable roof structure of a vehicle of claim 16, wherein said open roof mechanism stops moving of said roof member in the middle of opening or closing operation of the roof member at any position.

18. The movable roof structure of a vehicle of claim 15, further comprising an opening mechanism to vertically move at least part of said roof member.

19. The movable roof structure of a vehicle of claim 15, wherein one of said sub roof members is movable in a vehicle longitudinal direction.

20. A movable roof structure of a vehicle, comprising:
a roof member provided so as to be positioned in a closing state to cover over an upper part of a vehicle compartment and an open state to open the upper part of the vehicle compartment, the roof member comprising two split sub roof members which are connected to each other, at least one of which is made of a board-shaped hard roof member; the roof member being stored in a storage portion at a rear part of the vehicle compartment in a state in which the sub roof members are folded when being in the open state;
an operational member to be operated by a passenger, the operational member being provided at a specified position of a front-side member of the sub roof members so as to transmit an opening-operational force or a closing-operation force by the passenger to the sub roof members for opening or closing the roof member;
a moving mechanism provided to position the operational member such that the operational member is movable relatively to the roof member;
means for allowing daylight to come into the vehicle compartment is provided at least at part of the sub roof members; and
an open roof mechanism to provide a partially-open mode in which the roof member is partially open and held.
